(19) United States
(12) Patent Application Publication
(10) Pub. No.: US 2022/0340696 A1
(43) Pub. Date: Oct. 27, 2022

(54) POLYETHYLENE AND CHLORINATED POLYETHYLENE THEREOF

(71) Applicant: LG CHEM, LTD., Seoul (KR)

(72) Inventors: Si Jung LEE, Daejeon (KR); Sun Mi KIM, Daejeon (KR); Cheolhwan JEONG, Daejeon (KR); Bog Ki HONG, Daejeon (KR)

(73) Assignee: LG CHEM, LTD., Seoul (KR)

(21) Appl. No.: 17/638,958

(22) PCT Filed: Jun. 10, 2021
(86) PCT No.: PCT/KR2021/007264

§ 371 Date: Feb. 28, 2022

(30) Foreign Application Priority Data
Jun. 10, 2020 (KR) 10-2020-0070525
Jun. 9, 2021 (KR) 10-2021-0075020

(51) Int. Cl. C08F 110/02; C08F 8/22; C08F 4/659; C08F 4/6592

(52) U.S. Cl. CPC C08F 110/02; C08F 8/22; C08F 4/65912; C08F 4/65925

(57) ABSTRACT

The present disclosure relates to a polyethylene, which is reacted with chlorine to prepare a chlorinated polyethylene having excellent processability and size stability during high-speed extrusion by optimizing a high-crystalline region in a molecular structure, and a CPE compound including the same.

### CROSS CITATION WITH RELATED APPLICATION(S)

The present application is based on, and claims priority from, Korean Patent Application Nos. 10-2020-0070525 and 10-2021-0075020, filed on Jun. 10, 2020, and Jun. 9, 2021, respectively, the disclosures of which are hereby incorporated by reference herein in their entirety.

### TECHNICAL FIELD

The present invention relates to a polyethylene which may prepare a chlorinated polyethylene having excellent processability and size stability during high-speed extrusion by optimizing a high-crystalline region in a molecular structure, and a chlorinated polyethylene thereof.

### BACKGROUND

Chlorinated polyethylene prepared by reacting polyethylene with chlorine is known to have more improved physical and mechanical properties than polyethylene. In particular, since chlorinated polyethylene is able to resist harsh external environments, it may be used as a packing material such as various containers, fibers, or hoses, and the like, and a heat transfer material.

Chlorinated polyethylene (CPE) is widely used for wires and cables by compounding with inorganic additives and crosslinking agents, and may be generally prepared by reacting polyethylene with chlorine in a suspension, or by reacting polyethylene with chlorine in an aqueous HCl solution. This CPE compound product requires excellent tensile strength, and strength of the compound varies depending on physical properties of the chlorinated polyethylene. In the case of general-purpose chlorinated polyethylenes which are widely known at present, polyethylene prepared using a Ziegler-Natta catalyst is applied, and due to its broad molecular weight distribution, there is a disadvantage in that the tensile strength is poor when preparing the CPE compound. When a metallocene catalyst is applied, processability may be generally poor due to a narrow molecular weight distribution. However, the processability is improved by decreasing hardness of CPE due to excellent uniformity in chlorine distribution.

However, when processed into products such as thin electric wires or cables, and the like, a high-speed extrusion process is performed. Thus, a method of minimizing a processing-load has been continuously studied to improve extrusion processability and size stability even when polyethylene and chlorine are reacted and subjected to high-speed extrusion.

Accordingly, in order to remarkably improve extrusion processability and size stability during high-speed extrusion, excellent chlorine distribution uniformity is required in chlorinated polyethylene. To this end, there is a continuous demand for developing a process capable of preparing a polyethylene having a molecular structure in which a high-crystalline region is optimized.

### DETAILED DESCRIPTION OF THE INVENTION

### Technical Problem

In the present disclosure, there is provided a polyethylene which may prepare a chlorinated polyethylene having excellent processability and size stability during high-speed extrusion by optimizing a high-crystalline region in a molecular structure, and a chlorinated polyethylene thereof.

In addition, the present disclosure is to provide a process for preparing the polyethylene.

### Technical Solution

In an embodiment of the present disclosure, there is provided a polyethylene, having a MI₅ (a melt index measured at 190° C. under a load of 5 kg) of 0.8 g/10 min to 1.4 g/10 min, a melt flow rate ratio (MFRR_{21.6/5}, a value obtained by dividing a melt index measured at 190° C. under a load of 21.6 kg by the melt index measured at 190° C. under a load of 5 kg in accordance with ASTM D 1238) of 18 to 22, and a high-crystalline region ratio on a temperature rising elution fractionation (TREF) graph of 10% or less, wherein the high-crystalline region ratio is a percentage value obtained by dividing a graph area of the high-crystalline region at an elution temperature of 105° C. or higher by a total graph area.

In addition, the present disclosure provides a process for preparing the polyethylene.

The present disclosure also provides a chlorinated polyethylene prepared by reacting the polyethylene with chlorine.

### Advantageous Effects

A polyethylene according to the present disclosure has an optimized high-crystalline region in a molecular structure and is reacted with chlorine to prepare a chlorinated polyethylene having excellent processability and size stability during high-speed extrusion.

### BRIEF DESCRIPTION OF DRAWING

FIG. 1 shows a temperature rising elution fractionation (TREF) graph of a polyethylene of Example 1-1 and a polyethylene of Comparative Example 1-1 according to one embodiment of the present disclosure.

### DETAILED DESCRIPTION OF THE EMBODIMENTS

In the present disclosure, the terms “the first”, “the second”, etc. are used to describe a variety of components, and these terms are merely employed to distinguish a certain component from other components.

The terminology used herein is for the purpose of describing particular embodiments only and is not intended to be limiting of the invention. The singular forms are intended to include the plural forms as well, unless the context clearly indicates otherwise. It will be further understood that the terms “include”, “have”, or “possess”, when used in this specification, specify the presence of stated features, numbers, steps, components, or combinations thereof, but do not preclude the presence or addition of one or more other features, numbers, steps, components, or combinations thereof.

The terminology “about” or “substantially” used throughout the specification is intended to have meanings close to numerical values or ranges specified with an allowable error and intended to prevent accurate or absolute numerical values disclosed for understanding of the present invention from being illegally or unfairly used by any unconscionable third party.

Further, “parts by weight” as used herein refers to a relative concept of a ratio of the weight of the remaining material based on the weight of a specific material. For example, in a mixture containing 50 g of material A, 20 g of material B, and 30 g of material C, the amounts of materials B and C based on 100 parts by weight of material A are 40 parts by weight and 60 parts by weight, respectively.

In addition, “wt % (% by weight)” refers to an absolute concept of expressing the weight of a specific material in percentage based on the total weight. In the above-described mixture, the contents of materials A, B, and C based on 100% of the total weight of the mixture are 50% by weight, 20% by weight, and 30% by weight, respectively. At this time, a sum of the contents of respective components does not exceed 100% by weight.

As the present invention can be variously modified and have various forms, specific embodiments thereof are shown by way of examples and will be described in detail. However, it is not intended to limit the present invention to the particular form disclosed and it should be understood that the present invention includes all modifications, equivalents, and replacements within the idea and technical scope of the present invention.

Hereinafter, the present disclosure will be described in more detail.

According to one embodiment of the present disclosure, there is provided a polyethylene which may prepare a chlorinated polyethylene having excellent processability and size stability during high-speed extrusion by realizing a molecular structure in which a high-crystalline region is optimized.

The polyethylene is characterized in that MI₅ (a melt index measured at 190° C. under a load of 5 kg) is 0.8 g/10 min to 1.4 g/10 min, a melt flow rate ratio (MFRR_{21.6/5}, a value obtained by dividing a melt index measured at 190° C. under a load of 21.6 kg by the melt index measured at 190° C. under a load of 5 kg in accordance with ASTM D 1238) is 18 to 22, and a high-crystalline region ratio on a temperature rising elution fractionation (TREF) graph is 10% or less, wherein the high-crystalline region ratio is a percentage value obtained by dividing a graph area of the high-crystalline region at an elution temperature of 105° C. or higher by a total graph area.

The polyethylene according to the present disclosure may provide a chlorinated polyethylene having excellent processability and size stability during high-speed extrusion by optimizing the high-crystalline region in the molecular structure.

In particular, the polyethylene of the present disclosure has a reduced high-crystalline region in the molecular structure, and thus residual crystals of chlorinated polyethylene are reduced under the same chlorination conditions. As the residual crystals of chlorinated polyethylene are reduced, hardness becomes low, and a chlorinated polyethylene compound using the same has excellent dispersity, thereby remarkably improving processability indicated by Mooney viscosity and size stability indicated by plasticity.

The polyethylene according to the present disclosure may be an ethylene homopolymer without a separate copolymer.

The polyethylene is prepared by optimizing a specific metallocene catalyst as described below, and thus MI₅ (a melt index measured at 190° C. under a load of 5 kg) and a melt flow rate ratio (MFRR_{21.6/5}, a value obtained by dividing a melt index measured at 190° C. under a load of 21.6 kg by the melt index measured at 190° C. under a load of 5 kg in accordance with ASTM D 1238) are optimized, and at the same time, the high-crystalline region ratio on the temperature rising elution fractionation (TREF) graph is optimized, thereby providing a chlorinated polyethylene having excellent processability and size stability during high-speed extrusion and improving tensile strength and plasticity of a CPE compound.

The polyethylene has MI₅ of about 0.8 g/10 min to about 1.4 g/10 min, which is a melt index measured in accordance with ASTM D 1238 at 190° C. under a load of 5 kg, as described above. The melt index MI₅ may be about 1.4 g/10 min or less in terms of securing excellent thermal stability, because the lower the MI₅, the higher the viscosity, and thus changes in the polyethylene particle shape is small in a high-temperature slurry state for chlorination. In a more preferred range, the melt index MI₅ may be about 1.39 g/10 min or less, or about 1.38 g/10 min or less, or about 1.36 g/10 min or less, or about 1.35 g/10 min or less, or about 1.34 g/10 min or less, or about 1.32 g/10 min or less, or about 1.3 g/10 min or less. Further, the melt index MI₅ may be 0.8 g/10 min or more in terms of securing excellent processability, because the viscosity decreases as the MI increases. Specifically, the melt index MI₅ may be about 0.85 g/10 min or more, or about 0.9 g/10 min or more, or about 0.95 g/10 min or more, or about 1.0 g/10 min or more, or about 1.05 g/10 min or more, or about 1.1 g/10 min or more. In particular, it is desirable that the polyethylene has the above range of melt index MI₅, in terms of securing excellent extrusion processability and size stability even in a high-speed extrusion process when applied to electric wires or cables, and the like, and exhibiting excellent mechanical properties such as tensile strength, and the like.

Further, the polyethylene has a melt flow rate ratio (MFRR_{21.6/5}, a value obtained by dividing the melt index measured at 190° C. under a load of 21.6 kg by the melt index measured at 190° C. under a load of 5 kg in accordance with ASTM D 1238) of about 18 to about 22. Specifically, the melt flow rate ratio may be about 18 to about 21.5, or about 18 to about 21, or about 18.5 to about 21, or about 19 to about 21, or about 19 to about 20.5, or about 19 to about 20. The melt flow rate ratio should be about 18 or more in terms of processability during extrusion, and about 22 or less in terms of securing excellent mechanical properties by increasing Mooney viscosity (MV) of CPE.

The melt flow rate ratio (MFRR_{21.6/5}) is a value obtained by dividing the melt index measured at 190° C. under a load of 21.6 kg by the melt index measured at 190° C. under a load of 5 kg in accordance with ASTM D 1238. Here, the melt index MI_{21.6} may be about 20 g/10 min to about 30 g/10 min, or about 21 g/10 min to about 28 g/10 min, or about 22 g/10 min to about 26 g/10 min, as measured at 190° C. under a load of 21.6 kg in accordance with ASTM D 1238.

Further, the melt index MI_{2.16} of polyethylene may be about 0.01 g/10 min to about 0.45 g/10 min, as measured at 190° C. under a load of 2.16 kg in accordance with ASTM D 1238. The melt index MI_{2.16} may be about 0.45 g/10 min or less in terms of securing excellent thermal stability, as described above. In a more preferred range, the melt index MI_{2.16} may be about 0.44 g/10 min or less, about 0.43 g/10 min or less, about 0.42 g/10 min or less, about 0.41 g/10 min or less, or about 0.40 g/10 min or less. Further, the melt index MI_{2.16} may be 0.01 g/10 min or more in terms of securing excellent processability, as described above. Specifically, the melt index MI_{2.16} may be about 0.02 g/10 min or more, or about 0.05 g/10 min or more, or about 0.1 g/10 min or more, or about 0.15 g/10 min or more, or about 0.18 g/10 min or more, or about 0.2 g/10 min or more, or about 0.22 g/10 min or more, or about 0.24 g/10 min or more, or about 0.26 g/10 min or more, or about 0.28 g/10 min or more. In particular, it is desirable that the polyethylene has the above range of melt index MI_{2.16}, in terms of securing excellent extrusion processability and size stability even in a high-speed extrusion process when applied to electric wires or cables, and the like, and exhibiting excellent mechanical properties such as tensile strength.

Meanwhile, the polyethylene of the present disclosure is characterized by a low high-crystalline region ratio on the temperature rising elution fractionation (TREF) graph, together with the optimized melt index MI₅ and melt flow rate ratio (MFRR_{21.6/5}), as described above.

The polyethylene shows the low high-crystalline region ratio of about 10% or less or about 3% to about 10% on the temperature rising elution fractionation (TREF) graph. Specifically, the high-crystalline region ratio may be about 9.5% or less or about 3% to about 9.5%, or about 9% or less or about 3.5% to about 9%, or about 8.5% or less or about 4% to about 8.5%, or about 8.0% or less or about 5% to about 8.0%, or about 7.8% or less or about 5.5% to about 7.8%. Specifically, as the high-crystalline region ratio is lower, it is easier for chlorine molecules to penetrate into crystals, and thus the ratio should be about 10% or less in terms of uniform chlorination reaction. However, when the high-crystalline region ratio is too low, the crystal arrangement may easily change, chlorination productivity may decrease, and strength may be poor. In terms of preventing these problems, the high-crystalline region ratio may be about 3% or more.

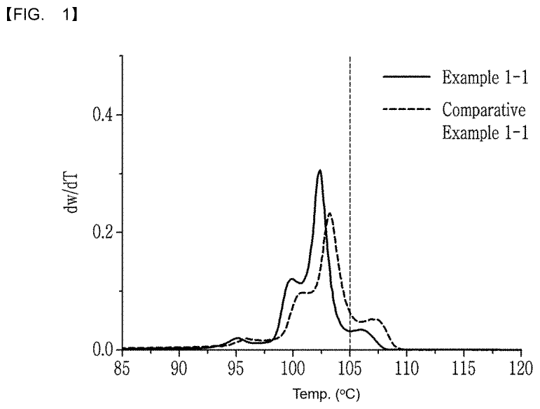

The high-crystalline region ratio may be obtained from a temperature rising elution fractionation (TREF) graph for polyethylene, as shown in one embodiment of FIG. 1. First, the temperature rising elution fractionation (TREF) graph for polyethylene is obtained, and then an elution temperature of 105° C. on the TREF graph is considered as a reference for the high-crystalline region. The elution temperature of 105° C. as the reference is made into the vertical axis, and the region having the elution temperature or higher is called a high-crystalline region. From this, a graph area of the high-crystalline region having an elution temperature or higher corresponding to a minimum value is measured, and the high-crystalline region ratio (%) is a percentage value obtained by dividing the graph area by a total graph area.

In particular, the temperature rising elution fractionation (TREF) graph for polyethylene may be obtained using Agilent Technologies 7890A manufactured by Polymer Char. For example, a sample is dissolved in 20 mL of 1,2,4-trichlorobenzene at a concentration of 1.5 mg/mL, then dissolved by increasing the temperature at a rate of 40° C./min from 30° C. to 150° C., then recrystallized by lowering the temperature at a rate of 0.5° C./min to 35° C., and then eluted by increasing the temperature at a rate of 1° C./min to 140° C. to obtain the graph.

The temperature rising elution fractionation (TREF) graph of polyethylene thus obtained has the elution temperature (° C.) on the X axis, and the amount of elution (dW/dt) at the corresponding temperature on Y the axis, as illustrated in one embodiment of FIG. 1. The region occupied by the graph corresponding to a temperature equal to or higher than the elution temperature of 105° C. on the temperature rising elution fractionation (TREF) graph is called the high-crystalline region. That is, the elution temperature of 105° C. is made into the vertical axis, and a value obtained by integrating an area of the graph having a temperature equal to or higher than the elution temperature may be referred to as an area of the high-crystalline region. A percentage value obtained by dividing the area of the high-crystalline region by a total graph area may be referred to as the high-crystalline region ratio.

Meanwhile, the polyethylene may have a density of about 0.955 g/cm³ to about 0.960 g/cm³, or about 0.9565 g/cm³ to about 0.9595 g/cm³, or about 0.956 g/cm³ to about 0.959 g/cm³. In particular, the polyethylene may have a density of about 0.955 g/cm³ or more, which means that the polyethylene has a high content of crystalline part and is dense, and the crystal structure of the polyethylene is difficult to change during chlorination. However, when the density of the polyethylene exceeds about 0.960 g/cm³, the content of crystalline structure of the polyethylene becomes too high, and as a result, the area of the high-crystalline region on TREF increases, and during CPE processing, the heat of fusion may increase and processability may decrease. Accordingly, it is desirable that the polyethylene of the present disclosure has the above range of density, in terms of securing excellent extrusion processability and size stability even in a high-speed extrusion process when applied to electric wires or cables, and the like, and exhibiting excellent mechanical properties such as tensile strength, and the like.

The polyethylene according to the present disclosure may have a molecular weight distribution of about 2 to about 10, or about 4 to about 10, or about 5 to about 9, or about 6.5 to about 8.2, or about 7.0 to about 8.0, or about 7.2 to about 7.6. In particular, since the polyethylene of the present disclosure has the above-described molecular weight distribution, CPE MV is 50 to 60 and a product with excellent processability may be obtained.

For example, the molecular weight distribution (MWD, polydispersity index) may be measured using gel permeation chromatography (GPC, manufactured by Water), and may be obtained by measuring a weight average molecular weight (Mw) and a number average molecular weight (Mn) of polyethylene, and then by dividing the weight average molecular weight by the number average molecular weight.

In particular, the weight average molecular weight (Mw) and the number average molecular weight (Mn) of polyethylene may be measured using a polystyrene calibration curve. For example, Waters PL-GPC220 may be used as the gel permeation chromatography (GPC) instrument, and a Polymer Laboratories PLgel MIX-B 300 mm length column may be used. In this regard, the measurement temperature may be 160° C., and 1,2,4-trichlorobenzene may be used as a solvent, and a flow rate of 1 mL/min may be applied. The polyethylene sample may be pretreated by dissolving in 1,2,4-trichlorobenzene containing 0.0125% of BHT at 160° C. for 10 hours using a GPC analyzer (PL-GP220), and the sample was prepared at a concentration of 10 mg/10 mL, and then may be supplied in an amount of 200 microleters (μL). Mw and Mn values may be obtained using a calibration curve formed using polystyrene standards. 9 kinds of polystyrene standards are used, the polystyrene standards having a weight average molecular weight of 2000 g/mol, 10000 g/mol, 30000 g/mol, 70000 g/mol, 200000 g/mol, 700000 g/mol, 2000000 g/mol, 4000000 g/mol, 10000000 g/mol.

The polyethylene may have a weight average molecular weight of about 110000 g/mol to about 250000 g/mol. Preferably, the polyethylene may have a weight average molecular weight of about 120000 g/mol or more, or about 125000 g/mol or more, or about 130000 g/mol or more, or about 135000 g/mol or more, or about 140000 g/mol or more, or about 145000 g/mol or more, or about 147000 g/mol or more. Further, the polyethylene may have a weight average molecular weight of about 220000 g/mol or less, or about 200000 g/mol or less, or about 180000 g/mol or less, or about 170000 g/mol or less, or about 160000 g/mol or less, or about 155000 g/mol or less, or about 153000 g/mol or less, which means a molecular weight suitable for obtaining CPE MV of 50 to 60 and excellent strength.

In particular, when the weight average molecular weight of polyethylene is too low, chlorination productivity may deteriorate during a chlorination process. For this reason, the weight average molecular weight of polyethylene may be about 110000 g/mol or more. However, when the weight average molecular weight of polyethylene is too high, processability may deteriorate. For this reason, the weight average molecular weight of polyethylene may be about 250000 g/mol or less. Preferably, the polyethylene of the present disclosure has the above range of the weight average molecular weight in terms of achieving excellent chlorination productivity when applied to electric wires or cables, and the like, and balanced physical properties of MV, processability, tensile strength, and plasticity.

Meanwhile, according to another embodiment of the present disclosure, there is provided a process for preparing the above-described polyethylene.

The process for preparing the polyethylene according to the present disclosure comprises the step of polymerizing ethylene in the presence of at least one first metallocene compound represented by the following Chemical Formula 1; and at least one second metallocene compound selected from compounds represented by the following Chemical Formula 2, wherein a weight ratio of the first metallocene compound and the second metallocene compound may be 40:60 to 45:55:

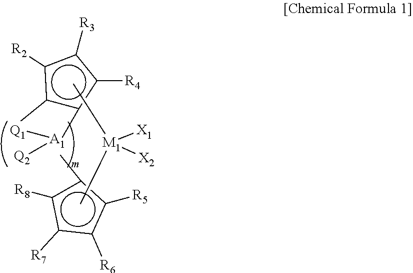

in Chemical Formula 1,

any one or more of R₁ to R₈ are —(CH₂)ₙ—OR, wherein R is C₁₋₆ linear or branched alkyl, and n is an integer of 2 to 6;

the rest of R₁ to R₈ are the same as or different from each other, and are each independently a functional group selected from the group consisting of hydrogen, halogen, C₁₋₂₀ alkyl, C₂₋₂₀ alkenyl, C₆₋₂₀ aryl, C₇₋₄₀ alkylaryl, and C₇₋₄₀ arylalkyl; or two or more of the substituents that are adjacent to each other are connected with each other to form a C₆₋₂₀ aliphatic or aromatic ring unsubstituted or substituted with a C₁₋₁₀ hydrocarbyl group;

Q₁ and Q₂ are the same as or different from each other, and are each independently hydrogen, halogen, C₁₋₂₀ alkyl, C₂₋₂₀ alkenyl, C₂₋₂₀ alkoxyalkyl, C₆₋₂₀ aryl, C₇₋₄₀ alkylaryl, or C₇₋₄₀ arylalkyl;

A₁ is carbon (C), silicon (Si), or germanium (Ge);

M₁ is a Group 4 transition metal;

X₁ and X₂ are the same as or different from each other, and are each independently halogen, C₁₋₂₀ alkyl, C₂₋₂₀ alkenyl, C₆₋₂₀ aryl, a nitro group, an amido group, C₁₋₂₀ alkylsilyl, C₁₋₂₀ alkoxy, or a C₁₋₂₀ sulfonate group; and

m is an integer of 0 or 1,

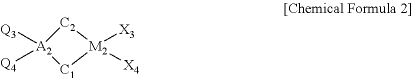

in Chemical Formula 2,

Q₃ and Q₄ are the same as or different from each other, and are each independently hydrogen, halogen, C₁₋₂₀ alkyl, C₂₋₂₀ alkenyl, C₂₋₂₀ alkoxyalkyl, C₆₋₂₀ aryl, C₇₋₄₀ alkylaryl, or C₇₋₄₀ arylalkyl;

A₂ is carbon (C), silicon (Si), or germanium (Ge);

M₂ is a Group 4 transition metal;

X₃ and X₄ are the same as or different from each other, and are each independently halogen, C₁₋₂₀ alkyl, C₂₋₂₀ alkenyl, C₆₋₂₀ aryl, a nitro group, an amido group, C₁₋₂₀ alkylsilyl, C₁₋₂₀ alkoxy, or a C₁₋₂₀ sulfonate group; and

any one of C₁ and C₂ is represented by the following Chemical Formula 3a or 3b, and the other is represented by the following Chemical Formula 3c, 3d, or 3e;

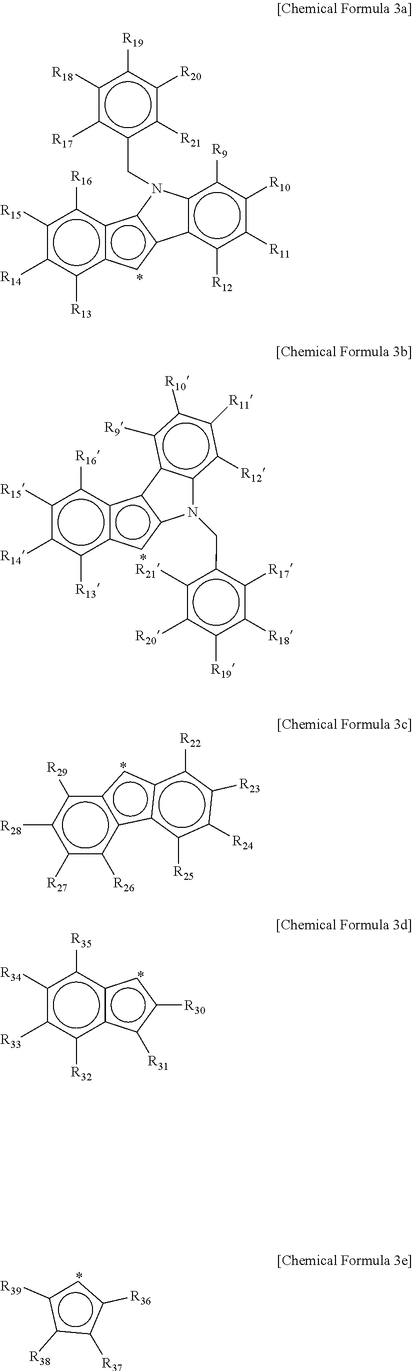

in Chemical Formulae 3a, 3b, 3c, 3d and 3e, R₉ to R₂₁ and R_{9′} to R_{21′} are the same as or different from each other, and are each independently hydrogen, halogen, C₁₋₂₀ alkyl, C₁₋₂₀ haloalkyl, C₂₋₂₀ alkenyl, C₁₋₂₀ alkylsilyl, C₁₋₂₀ silylalkyl, C₁₋₂₀ alkoxysilyl, C₁₋₂₀ alkoxy, C₆₋₂₀ aryl, C₇₋₄₀ alkylaryl, or C₇₋₄₀ arylalkyl, provided that one or more of R₁₇ to R₂₁ or one or more of R_{17′} to R_{21′} are C₁₋₂₀ haloalkyl;

R₂₂ to R₃₉ are the same as or different from each other, and are each independently hydrogen, halogen, C₁₋₂₀ alkyl, C₁₋₂₀ haloalkyl, C₂₋₂₀ alkenyl, C₁₋₂₀ alkylsilyl, C₁₋₂₀ silylalkyl, C₁₋₂₀ alkoxysilyl, C₁₋₂₀ alkoxy, C₆₋₂₀ aryl, C₇₋₄₀ alkylaryl, or C₇₋₄₀ arylalkyl, or two or more of R₂₂ to R₃₉ that are adjacent to each other may be connected with each other to form a C₆₋₂₀ aliphatic or aromatic ring unsubstituted or substituted with a C₁₋₁₀ hydrocarbyl group; and

* represents a site of binding to A₂ and M₂.

Unless otherwise specified herein, the following terms may be defined as follows.

The halogen may be fluorine (F), chlorine (Cl), bromine (Br) or iodine (I).

The hydrocarbyl group is a monovalent functional group in which a hydrogen atom is removed from hydrocarbon. The hydrocarbyl group may include an alkyl group, an alkenyl group, an alkynyl group, an aryl group, an aralkyl group, an aralkenyl group, an aralkynyl group, an alkylaryl group, an alkenylaryl group, or an alkynylaryl group, and the like. In addition, the C₁₋₃₀ hydrocarbyl group may be a C₁₋₂₀ hydrocarbyl group or a hydrocarbyl group. For example, the hydrocarbyl group may be linear, branched, or cyclic alkyl. More specifically, the C₁₋₃₀ hydrocarbyl group may be a linear, branched, or cyclic alkyl group such as a methyl group, an ethyl group, an n-propyl group, an iso-propyl group, an n-butyl group, an iso-butyl group, a tert-butyl group, an n-pentyl group, an n-hexyl group, an n-heptyl group, or a cyclohexyl group, and the like; or an aryl group such as phenyl, biphenyl, naphthyl, anthracenyl, phenanthrenyl, or fluorenyl, and the like. Moreover, it may be alkylaryl such as methylphenyl, ethylphenyl, methylbiphenyl, or methylnaphthyl, and the like, or arylalkyl such as phenylmethyl, phenylethyl, biphenylmethyl, or naphthylmethyl, and the like. It may also be alkenyl such as allyl, ethenyl, propenyl, butenyl, or pentenyl, and the like

In addition, the C₁₋₂₀ alkyl may be linear, branched, or cyclic alkyl. Specifically, the C₁₋₂₀ alkyl may be C₁₋₂₀ linear alkyl; C₁₋₁₅ linear alkyl; C₁₋₅ linear alkyl; C₃₋₂₀ branched or cyclic alkyl; C₃₋₁₅ branched or cyclic alkyl; or C₃₋₁₀ branched or cyclic alkyl. For example, the C₁₋₂₀ alkyl may include methyl, ethyl, propyl, isopropyl, n-butyl, tert-butyl, pentyl, hexyl, heptyl, octyl, cyclopropyl, cyclobutyl, cyclopentyl, cyclohexyl, cycloheptyl, or cyclooctyl, and the like, but is not limited thereto.

The C₂₋₂₀ alkenyl includes linear or branched alkenyl, and may specifically include allyl, ethenyl, propenyl, butenyl, or pentenyl, and the like, but is not limited thereto.

The C₁₋₂₀ alkoxy may include methoxy, ethoxy, isopropoxy, n-butoxy, tert-butoxy, or cyclohexyloxy, and the like, but is not limited thereto.

The C₂₋₂₀ alkoxyalkyl group is a functional group in which one or more hydrogens of the above-mentioned alkyl are substituted with alkoxy. Specifically, the C₂₋₂₀ alkoxyalkyl group may include methoxymethyl, methoxyethyl, ethoxymethyl, iso-propoxymethyl, iso-propoxyethyl, iso-propoxypropyl, iso-propoxyhexyl, tert-butoxymethyl, tert-butoxyethyl, tert-butoxypropyl, or tert-butoxyhexyl, and the like, but is not limited thereto.

The C₆₋₄₀ aryloxy may include phenoxy, biphenoxyl, or naphthoxy, and the like, but is not limited thereto.

The C₇₋₄₀ aryloxyalkyl group is a functional group in which one or more hydrogens of the above-mentioned alkyl are substituted with aryloxy. Specifically, the C₇₋₄₀ aryloxyalkyl group may include phenoxymethyl, phenoxyethyl, or phenoxyhexyl, and the like, but is not limited thereto.

The C₁₋₂₀ alkylsilyl or the C₁₋₂₀ alkoxysilyl is a functional group in which 1 to 3 hydrogens of —SiH₃ are substituted with 1 to 3 alkyl groups or alkoxy groups described above. Specifically, it may include alkylsilyl such as methylsilyl, dimethylsilyl, trimethylsilyl, dimethylethylsilyl, diethylmethylsilyl, or dimethylpropylsilyl, and the like; alkoxysilyl such as methoxysilyl, dimethoxysilyl, trimethoxysilyl, or dimethoxyethoxysilyl, and the like; or alkoxyalkylsilyl such as methoxydimethylsilyl, diethoxymethylsilyl, or dimethoxypropylsilyl, and the like, but is not limited thereto.

The C₁₋₂₀ silylalkyl is a functional group in which one or more hydrogens of the above-mentioned alkyl are substituted with silyl. Specifically, the C₁₋₂₀ silylalkyl may include —CH₂—SiH₃, methylsilylmethyl, or dimethylethoxysilylpropyl, and the like, but is not limited thereto.

In addition, the C₁₋₂₀ alkylene is the same as the above-mentioned alkyl except that it is a divalent substituent. Specifically, the C₁₋₂₀ alkylene include methylene, ethylene, propylene, butylene, pentylene, hexylene, heptylene, octylene, cyclopropylene, cyclobutylene, cyclopentylene, cyclohexylene, cycloheptylene, or cyclooctylene, and the like, but is not limited thereto.

The C₆₋₂₀ aryl may be a monocyclic, bicyclic or tricyclic aromatic hydrocarbon. For example, the C₆₋₂₀ aryl may include phenyl, biphenyl, naphthyl, anthracenyl, phenanthrenyl, or fluorenyl, and the like, but is not limited thereto.

The C₇₋₂₀ alkylaryl may refer to a substituent in which one or more hydrogens of the aromatic ring are substituted with the above-mentioned alkyl. For example, the C₇₋₂₀ alkylaryl may include methylphenyl, ethylphenyl, methylbiphenyl, or methylnaphthyl, and the like, but is not limited thereto.

The C₇₋₂₀ arylalkyl may refer to a substituent in which one or more hydrogens of the alkyl are substituted with the above-mentioned aryl. For example, the C₇₋₂₀ arylalkyl may include phenylmethyl, phenylethyl, biphenylmethyl, or naphthylmethyl, and the like, but is not limited thereto.

In addition, the C₆₋₂₀ arylene is the same as the above-mentioned aryl except that it is a divalent substituent. Specifically, the C₆₋₂₀ arylene may include phenylene, biphenylene, naphthylene, anthracenylene, phenanthrenylene, or fluorenylene, and the like, but is not limited thereto.

The Group 4 transition metal may be titanium (Ti), zirconium (Zr), hafnium (Hf), or rutherfordium (Rf). Specifically, the Group 4 transition metal may be titanium (Ti), zirconium (Zr), or hafnium (Hf). More specifically, it may be zirconium (Zr), or hafnium (Hf), but is not limited thereto.

Further, the Group 13 element may be boron (B), aluminum (A1), gallium (Ga), indium (In), or thallium (TI). Specifically, the Group 13 element may be boron (B) or aluminum (Al), but is not limited thereto.

Meanwhile, the first metallocene compound may be represented by any one of the following Chemical Formulae 1-1 to 1-4:

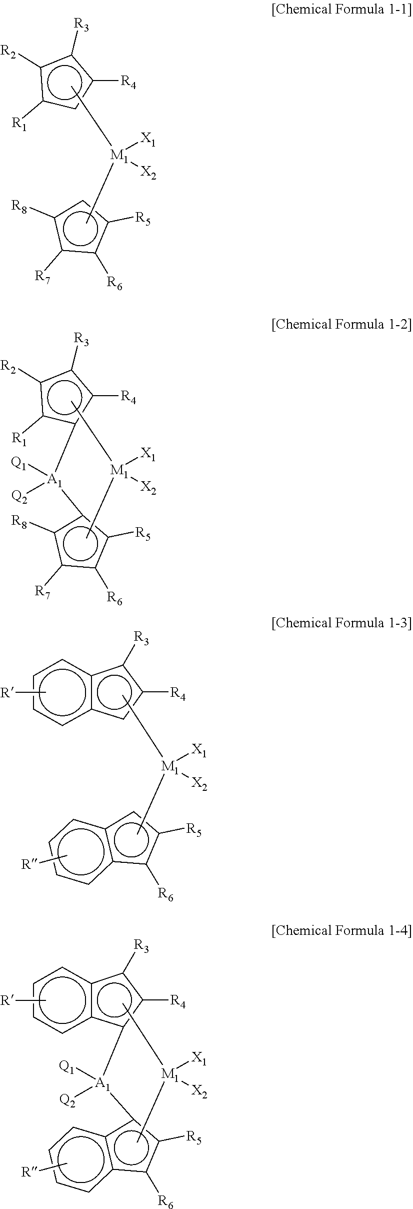

in Chemical Formulae 1-1 to 1-4, Q₁, Q₂, A₁, M₁, X₁, X₂, and R₁ to R₈ are the same as defined in Chemical Formula 1, and R′ and R″ are the same as or different from each other, and are each independently a C₁₋₁₀ hydrocarbyl group.

Preferably, the first metallocene compound may have a structure including a bis-cyclopentadienyl ligand, and more preferably, including cyclopentadienyl ligands configured symmetrically with respect to a transition metal. More preferably, the first metallocene compound may be represented by Chemical Formula 1-1.

In Chemical Formula 1 and Chemical Formulae 1-1 to 1-4, any one or more of R₁ to R₈ may be —(CH₂)ₙ—OR, wherein R is C₁₋₆ linear or branched alkyl, and n is an integer of 2 to 6. Specifically, R is C₁₋₄ linear or branched alkyl, and n is an integer of 4 to 6. For example, any one or more of R₁ to R₈ may be C₂₋₆ alkyl substituted with C₁₋₆ alkoxy, or C₄₋₆ alkyl substituted with C₁₋₄ alkoxy.

In Chemical Formula 1 and Chemical Formulae 1-1 to 1-4, the rest of R₁ to R₈ may be the same as or different from each other, and may be each independently a functional group selected from the group consisting of hydrogen, halogen, C₁₋₂₀ alkyl, C₂₋₂₀ alkenyl, C₆₋₂₀ aryl, C₇₋₄₀ alkylaryl, and C₇₋₄₀ arylalkyl; or two or more of the substituents that are adjacent to each other may be connected with each other to form a C₆₋₂₀ aliphatic or aromatic ring unsubstituted or substituted with a C₁₋₁₀ hydrocarbyl group.

Specifically, the rest of R₁ to R₈ may be each hydrogen, or C₁₋₂₀ alkyl, or C₁₋₁₀ alkyl, or C₁₋₆ alkyl, or C₂₋₆ alkyl substituted with C₁₋₆ alkoxy, or C₄₋₆ alkyl substituted with C₁₋₄ alkoxy. Alternatively, two or more of R₁ to R₈ that are adjacent to each other may be connected with each other to form a C₆₋₂₀ aliphatic or aromatic ring substituted with C₁₋₃ hydrocarbyl group.

Preferably, in Chemical Formula 1 and Chemical Formulae 1-1 to 1-4, R₃ and R₆ may be each C₁₋₆ alkyl, or C₂₋₆ alkyl substituted with C₁₋₆ alkoxy, provided that one or more of R₃ and R₆ are C₂₋₆ alkyl substituted with C₁₋₆ alkoxy. Alternatively, R₃ and R₆ may be each C₄₋₆ alkyl, or C₄₋₆ alkyl substituted with C₁₋₄ alkoxy, provided that one or more of R₃ and R₆ are C₄₋₆ alkyl substituted with C₁₋₄ alkoxy. For example, R₃ and R₆ may be each n-butyl, n-pentyl, n-hexyl, tert-butoxy butyl, or tert-butoxy hexyl, provided that one or more of R₃ and R₆ are tert-butoxy butyl or tert-butoxy hexyl. Preferably, R₃ and R₆ may be the same as each other and may be tert-butoxy butyl or tert-butoxy hexyl.

In addition, in Chemical Formula 1 and Chemical Formulae 1-1 to 1-4, R₁, R₂, R₄, R₅, R₇, and R₈ may be hydrogen.

In Chemical Formula 1, Chemical Formula 1-2, and Chemical Formula 1-4, Q₁ and Q₂ are the same as or different from each other, and are each independently hydrogen, halogen, C₁₋₂₀ alkyl, C₂₋₂₀ alkenyl, C₂₋₂₀ alkoxyalkyl, C₆₋₂₀ aryl, C₇₋₄₀ alkylaryl, or C₇₋₄₀ arylalkyl.

Specifically, Q₁ and Q₂ may be each C₁₋₁₂ alkyl, or C₁₋₆ alkyl, or C₁₋₃ alkyl. Preferably, Q₁ and Q₂ may be the same as each other and may be C₁₋₃ alkyl. More preferably, Q₁ and Q₂ may be methyl.

In Chemical Formula 1 and Chemical Formulae 1-1 to 1-4, A₁ may be carbon (C), silicon (Si), or germanium (Ge). Specifically, A₁ may be silicon (Si).

In Chemical Formula 1 and Chemical Formulae 1-1 to 1-4, M₁ is a Group 4 transition metal. Specifically, M₁ may be zirconium (Zr) or hafnium (Hf), and preferably zirconium (Zr).

In Chemical Formula 1 and Chemical Formulae 1-1 to 1-4, X₁ and X₂ are the same as or different from each other, and are each independently halogen, C₁₋₂₀ alkyl, C₂₋₂₀ alkenyl, C₆₋₂₀ aryl, a nitro group, an amido group, C₁₋₂₀ alkylsilyl, C₁₋₂₀ alkoxy, or a C₁₋₂₀ sulfonate group. Specifically, X₁ and X₂ may be each halogen, and may be each chloro, iodine, or bromine. Preferably, X₁ and X₂ may be chloro.

In Chemical Formula 1, m is an integer of 0 or 1, and preferably m is 0.

The compound represented by Chemical Formula 1 may be, for example, a compound represented by any one of the following structural formulae, but is not limited thereto:

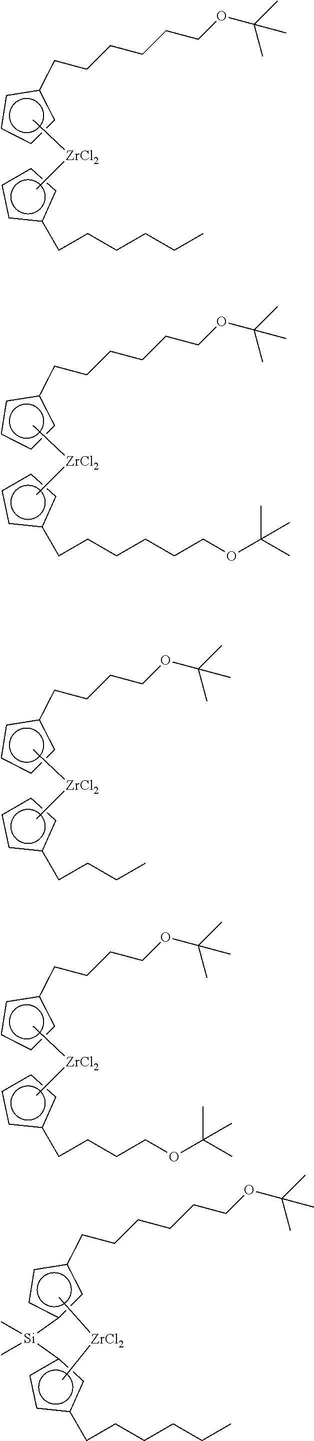

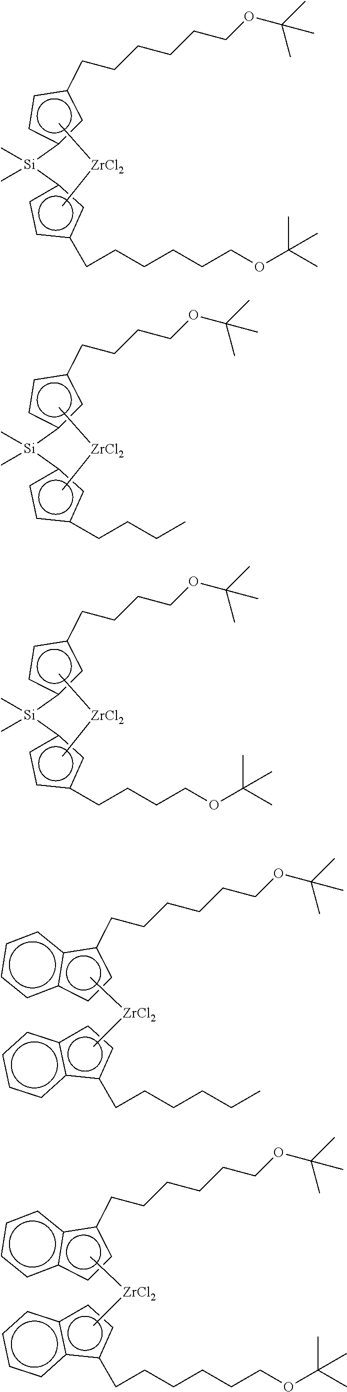

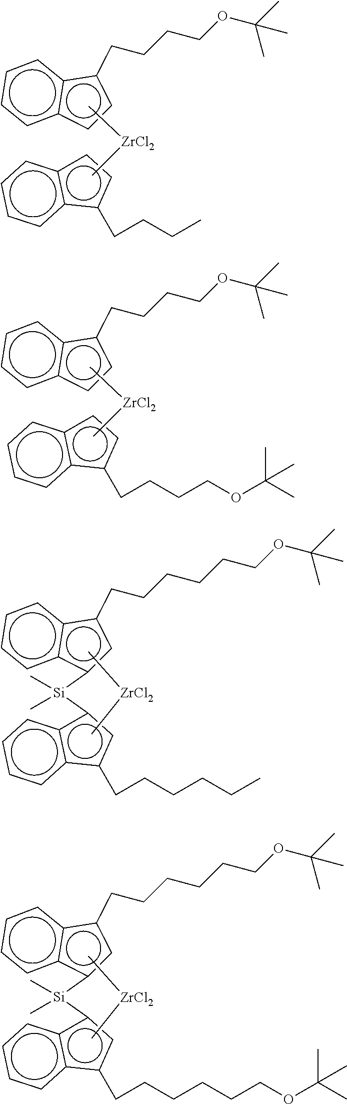

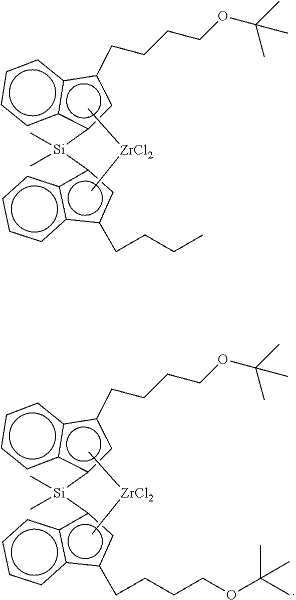

Preferably, the first metallocene compound may be a compound represented by any one of the following structural formulae:

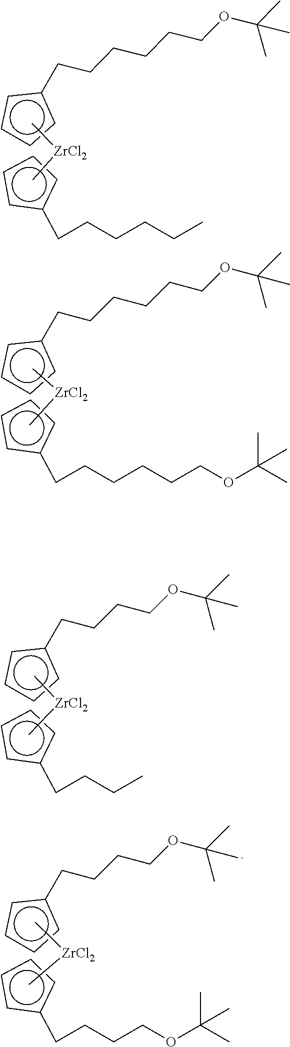

More preferably, the first metallocene compound may be a compound represented by any one of the following structural formulae:

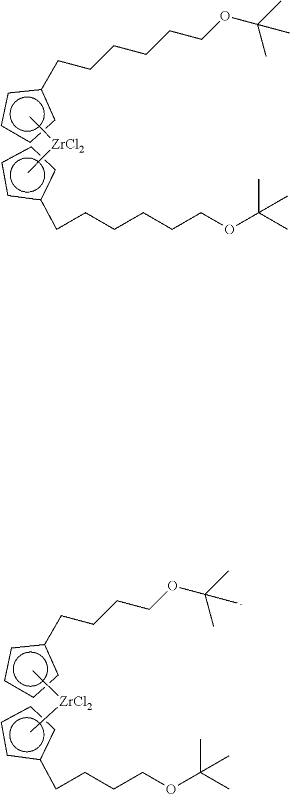

The first metallocene compound represented by the above structural formula may be synthesized by applying known reactions, and a detailed synthesis method may be referred to Examples.

In the process for preparing the polyethylene according to the present disclosure, one or more kinds of the first metallocene compound represented by Chemical Formula 1, or Chemical Formula 1-1, 1-2, 1-3, or 1-4 as described above are used together with one or more kinds of the second metallocene compound described below. Thus, it is possible to improve productivity, and tensile strength and plasticity of a CPE compound while achieving excellent extrusion processability and size stability even during high-speed extrusion in the CPE process described below by optimizing the melt index MI₅ and the melt flow rate ratio (MFRR_{21.6/5}) of polyethylene, and at the same time, by optimizing the high-crystalline region ratio according to temperature rising elution fractionation (TREF) analysis.

Meanwhile, the second metallocene compound may be represented by the following Chemical Formula 2-1:

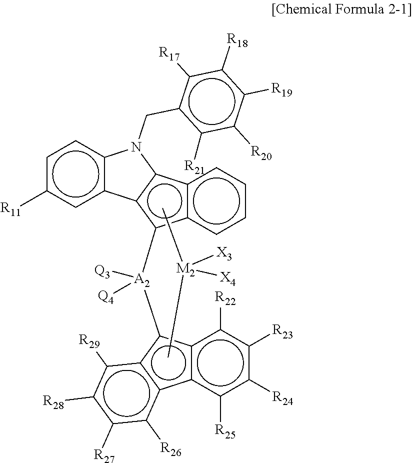

in Chemical Formula 2-1, Q₃, Q₄, A₂, M₂, X₃, X₂₄, R₁₁, and R₁₇ to R₂₉ are the same as defined in Chemical Formula 2.

In Chemical Formulae 2 and 2-1, Q₃ and Q₄ are the same as or different from each other, and are each independently hydrogen, halogen, C₁₋₂₀ alkyl, C₂₋₂₀ alkenyl, C₂₋₂₀ alkoxyalkyl, C₆₋₂₀ aryl, C₇₋₄₀ alkylaryl, or C₇₋₄₀ arylalkyl. Specifically, Q₃ and Q₄ may be each C₁₋₁₂ alkyl, or C₁₋₈ alkyl, or C₁₋₃ alkyl, or C₂₋₁₈ alkoxyalkyl, or C₂₋₁₄ alkoxyalkyl, or C₂₋₁₂ alkoxyalkyl, and more specifically, Q₃ and Q₄ may be each C₁₋₃ alkyl or C₂₋₁₂ alkoxyalkyl. Preferably, Q₃ and Q₄ may be different from each other, and one of Q₃ and Q₄ may be C₁₋₃ alkyl, and the other may be C₂₋₁₂ alkoxyalkyl. More preferably, one of Q₃ and Q₄ may be methyl, and the other may be tert-butoxyhexyl.

In Chemical Formulae 2 and 2-1, A₂ may be carbon (C), silicon (Si), or germanium (Ge). Specifically, A₂ may be silicon (Si).

In Chemical Formulae 2 and 2-1, M₂ is a Group 4 transition metal. Specifically, M₂ may be zirconium (Zr) or hafnium (Hf), and preferably, zirconium (Zr).

In Chemical Formulae 2 and 2-1, X₃ and X₄ are the same as or different from each other, and are each independently halogen, C₁₋₂₀ alkyl, C₂₋₂₀ alkenyl, C₆₋₂₀ aryl, a nitro group, an amido group, C₁₋₂₀ alkylsilyl, C₁₋₂₀ alkoxy, or a C₁₋₂₀ sulfonate group. Specifically, X₃ and X₄ may be each halogen, and may be each chloro, iodine, or bromine. Preferably, X₃ and X₄ may be chloro.

In Chemical Formula 2, one of C₁ and C₂ may be represented by Chemical Formula 3a or Chemical Formula 3b, and the other of C₁ and C₂ may be represented by Chemical Formula 3c, Chemical Formula 3d, or Chemical Formula 3e, and preferably, represented by Chemical Formula 3c.

In Chemical Formulae 2 and 2-1, R₉ to R₂₁ and R_{9′} to R_{21′} are the same as or different from each other, and are each independently hydrogen, halogen, C₁₋₂₀ alkyl, C₁₋₂₀ haloalkyl, C₂₋₂₀ alkenyl, C₁₋₂₀ alkylsilyl, C₁₋₂₀ silylalkyl, C₁₋₂₀ alkoxysilyl, C₁₋₂₀ alkoxy, C₆₋₂₀ aryl, C₇₋₄₀ alkylaryl, or C₇₋₄₀ arylalkyl, provided that one or more of R₁₇ to R₂₁ or one or more of R_{17′} to R_{21′} are C₁₋₂₀ haloalkyl.

Specifically, in Chemical Formula 2, R₉ to R₁₀ and R₁₂ to R₁₆ and R_{9′} to R_{10′} and R_{12′} to R_{16′} may be hydrogen.

In Chemical Formulae 2 and 2-1, R₁₁ and R_{11′} may be each C₁₋₆ linear or branched alkyl, or C₁₋₃ linear or branched alkyl, and preferably, may be methyl.

Specifically, in Chemical Formulae 2 and 2-1, R₁₇ to R₂₁ or R_{17′} to R_{21′} may be each hydrogen or C₁₋₆ haloalkyl, provided that one or more of R₁₇ to R₂₁ or one or more of R_{17′} to R_{21′} are C₁₋₆ haloalkyl. Alternatively, R₁₇ to R₂₁ or R_{17′} to R_{21′} may be each hydrogen or C₁₋₃ haloalkyl, provided that one or more of R₁₇ to R₂₁ or one or more of R_{17′} to R_{21′} are C₁₋₃ haloalkyl. For example, R₁₇ to R₂₀ or R_{17′} to R_{20′} are hydrogen, and R₂₁ or R_{21′} is trihalomethyl, and preferably, trifluoromethyl.

In Chemical Formulae 2 and 2-1, R₂₂ to R₃₉ are the same as or different from each other, and are each independently hydrogen, halogen, C₁₋₂₀ alkyl, C₁₋₂₀ haloalkyl, C₂₋₂₀ alkenyl, C₁₋₂₀ alkylsilyl, C₁₋₂₀ silylalkyl, C₁₋₂₀ alkoxysilyl, C₁₋₂₀ alkoxy, C₆₋₂₀ aryl, C₇₋₄₀ alkylaryl, or C₇₋₄₀ arylalkyl, or two or more of R₂₂ to R₃₉ that are adjacent to each other may be connected with each other to form a C₆₋₂₀ aliphatic or aromatic ring unsubstituted or substituted with a C₁₋₁₀ hydrocarbyl group.

Specifically, R₂₂ to R₂₉ may be each hydrogen, or C₁₋₂₀ alkyl, or C₁₋₁₀ alkyl, or C₁₋₆ alkyl, or C₁₋₃ alkyl. Alternatively, two or more of R₂₂ to R₂₉ that are adjacent to each other may be connected with each other to form a C₆₋₂₀ aliphatic or aromatic ring substituted with C₁₋₃ hydrocarbyl group. Preferably, R₂₂ to R₂₉ may be hydrogen.

Specifically, in Chemical Formulae 2 and 2-1, R₃₀ to R₃₅ may be each hydrogen, or C₁₋₂₀ alkyl, or C₁₋₁₀ alkyl, or C₁₋₆ alkyl, or C₁₋₃ alkyl.

In Chemical Formulae 2 and 2-1, R₂₆ to R₂₉ may be each hydrogen, or C₁₋₂₀ alkyl, or C₁₋₁₀ alkyl, or C₁₋₆ alkyl, or C₁₋₃ alkyl.

The compound represented by Chemical Formula 2 may be, for example, a compound represented by the following structural formula, but is not limited thereto:

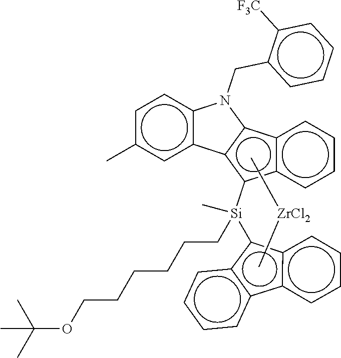

The second metallocene compound represented by the above structural formula may be synthesized by applying known reactions, and a detailed synthesis method may be referred to Examples.

A process for preparing the metallocene compound is described in detail in Examples to be described later.

The metallocene catalyst used in the present disclosure may be supported on a support together with a cocatalyst compound.

In the supported metallocene catalyst according to the present disclosure, the cocatalyst supported on a support for activating the metallocene compound is an organometallic compound containing a Group 13 metal, and is not particularly limited as long as it may be used in the polymerization of olefins in the presence of a general metallocene catalyst.

The cocatalyst is an organometallic compound containing a Group 13 metal, and is not particularly limited as long as it may be used in the polymerization of ethylene in the presence of a general metallocene catalyst.

Specifically, the cocatalyst may be one or more selected from the group consisting of compounds represented by the following Chemical Formulae 4 to 6:

—[Al(R₄₀)—O]_{c}— [Chemical Formula 4]

in Chemical Formula 4,

R₄₀ is each independently halogen, C₁₋₂₀ alkyl, or C₁₋₂₀ haloalkyl,

c is an integer of 2 or more,

D(R₄₁)₃ [Chemical Formula 5]

in Chemical Formula 5,

D is aluminum or boron, and

R₄₁'s are each independently hydrogen, halogen, C₁₋₂₀ hydrocarbyl or C₁₋₂₀ hydrocarbyl substituted with halogen,

[L-H]⁺[Q(E)₄]⁻or [L]⁺[Q(E)₄]⁻ [Chemical Formula 6]

in Chemical Formula 6,

L is a neutral or cationic Lewis base,

[L-H]+ is a bronsted acid,

Q is B³⁺ or Al³⁺, and

E's are each independently C₆₋₂₀ aryl or C₁₋₂₀ alkyl, wherein C₆₋₂₀ aryl or C₁₋₂₀ alkyl is unsubstituted or substituted with one or more substituents selected from the group consisting of halogen, C₁₋₂₀ alkyl, C₁₋₂₀ alkoxy, and phenoxy.

The compound represented by Chemical Formula 4 may be, for example, alkylaluminoxane such as modified methyl aluminoxane (MMAO), methyl aluminoxane (MAO), ethylaluminoxane, isobutylaluminoxane, or butylaluminoxane, and the like

The alkyl metal compound represented by Chemical Formula 5 may be, for example, trimethylaluminum, triethylaluminum, triisobutylaluminum, tripropylaluminum, tributylaluminum, dimethylchloroaluminum, dimethylisobutylaluminum, dimethylethylaluminum, diethylchloroaluminum, triisopropylaluminum, tri-t-butylaluminum, tricyclopentylaluminum, tripentylaluminum, triisopentylaluminum, trihexylaluminum, ethyldimethylaluminum, methyldiethylaluminum, triphenylaluminum, tri-p-tolylaluminum, dimethylaluminummethoxide, dimethylaluminumethoxide, trimethylboron, triethylboron, triisobutylboron, tripropylboron, or tributylboron, and the like

The compound represented by Chemical Formula 6 may be, for example, triethylammoniumtetraphenylboron, tributylammoniumtetraphenylboron, trimethylammoniumtetraphenylboron, tripropylammoniumtetraphenylboron, trimethylammoniumtetra(p-tolyl)boron, tripropylammoniumtetra(p-tolyl)boron, triethylammoniumtetra(o,p-dimethylphenyl)boron, trimethylammoniumtetra(o,p-dimethylphenyl)boron, tributylammoniumtetra(p-trifluoromethylphenyl)boron, trimethylammoniumtetra(p-trifluoromethylphenyl)boron, tributylammoniumtetrapentafluorophenylboron, N,N-diethylaniliniumtetraphenyl boron, N,N-dimethylaniliniumtetraphenylboron, N,N-diethylaniliniumtetrapentafluorophenylboron, diethylammoniumtetrapentafluorophenylboron, triphenylphosphoniumtetraphenylboron, trimethylphosphoniumtetraphenylboron, triethylammoniumtetraphenylaluminum, tributylammoniumtetraphenylaluminum, trimethylammoniumtetraphenylaluminum, tripropylammoniumtetraphenylaluminum, trimethylammoniumtetra(p-tolyl)aluminum, tripropylammoniumtetra(p-tolyl)aluminum, triethylammoniumtetra(o,p-dimethylphenyl)aluminum, tributylammoniumtetra(p-trifluoromethylphenyl)aluminum, trimethylammoniumtetra(p-trifluoromethylphenyl)aluminum,tributylammoniumtetrapentafluorophenylaluminum, N,N-diethylaniliniumtetraphenylaluminum, N,N-dimethylaniliniumtetraphenylaluminum, N,N-diethylaniliniumtetrapentafluorophenylaluminum, diethylammoniumtetrapentafluorophenylaluminum, triphenylphosphoniumtetraphenylaluminum, trimethylphosphoniumtetraphenylaluminum, triphenylcarboniumtetraphenylboron, triphenylcarboniumtetraphenylaluminum, triphenylcarboniumtetra(p-trifluoromethylphenyl)boron, or triphenylcarboniumtetrapentafluorophenylboron, and the like

The cocatalyst may be supported in an amount of about 5 mmol to about 20 mmol, based on 1 g of the support.

In the supported metallocene catalyst according to the present disclosure, a support containing hydroxyl groups on the surface may be used as the support. Preferably, a support containing highly reactive hydroxyl groups and siloxane groups which is dried to remove moisture on the surface may be used.

For example, silica, silica-alumina, or silica-magnesia dried at a high temperature may be used, and may commonly include oxide, carbonate, sulfate, and nitrate, such as Na₂O, K₂CO₃, BaSO₄, or Mg(NO₃)₂, and the like

A drying temperature of the support may be preferably about 200° C. to about 800° C., more preferably about 300° C. to about 600° C., and most preferably, about 300° C. to about 400° C. When the drying temperature of the support is lower than about 200° C., surface moisture may react with the cocatalyst due to excessive moisture. When it is higher than about 800° C., pores on the surface of the support may be combined to reduce the surface area, and a lot of hydroxyl groups may be lost on the surface and only siloxane groups may remain, thus decreasing the reaction sites with the cocatalyst, which is not preferable.

The amount of the hydroxyl groups on the surface of the support may be preferably about 0.1 mmol/g to about 10 mmol/g, and more preferably about 0.5 mmol/g to about 5 mmol/g. The amount of the hydroxyl groups on the surface of the support may be controlled by the preparation method and conditions of the support, or drying conditions, for example, temperature, time, vacuum, or spray drying, and the like

When the amount of the hydroxyl groups is less than about 0.1 mmol/g, the reaction sites with the cocatalyst may be little, and when it is more than about 10 mmol/g, there is a possibility of being derived from moisture other than hydroxyl groups on the surface of the support particle, which is not preferable.

In the supported metallocene catalyst of the present disclosure, a weight ratio of the total transition metal included in the metallocene catalyst to the support may be about 1:10 to 1:1000. When the support and the metallocene compounds are included within the above weight ratio, an optimal shape may be exhibited. In addition, a weight ratio of the cocatalyst compound to the support may be about 1:1 to 1:100.

The ethylene polymerization reaction may be carried out using a single continuous slurry polymerization reactor, loop slurry reactor, gas phase reactor, or solution reactor.

In particular, the polyethylene according to the present disclosure may be prepared by homopolymerizing ethylene in the presence one or more kinds of the first metallocene compound represented by Chemical Formula 1; and one or more kinds of the second metallocene compound selected from the compounds represented by Chemical Formula 2.

A weight ratio of the first metallocene compound and the second metallocene compound may be, for example, about 40:60 to about 45:55. Specifically, the weight ratio of the first and second metallocene compounds may be about 41:59 to about 44:56, or about 42:58 to about 43:57. The weight ratio of the catalyst precursor may be within the above range in terms of optimizing a high-crystalline region in a molecular structure in order to prepare a chlorinated polyethylene and a CPE compound having high extrusion processability and excellent size stability even during high-speed extrusion in a process of manufacturing electric wires or cables, and the like by optimizing the high-crystalline region in the molecular structure. Specifically, the weight ratio may be about 40:60 or more in terms of securing MFRR(21.6/5) of 18 or more and may be about 45:55 or less in terms of optimizing MFRR(21.6/5) of 22 or less, when the high-crystalline region ratio of polyethylene is 10% or less and the melt index MI₅ is 0.8 g/10 min to 1.4 g/10 min.

Further, in the present disclosure, the polyethylene may be prepared under the metallocene catalyst as described above while introducing hydrogen gas. In this regard, the hydrogen gas may be introduced in an amount of about 100 ppm to about 150 ppm, or about 110 ppm to about 140 ppm, or about 115 ppm to about 135 ppm, or about 120 ppm to about 130 ppm. The input amount of hydrogen gas may be maintained within the above range, in terms of maintaining the optimal range of the melt index MI₅ and the melt flow rate ratio of the polyethylene obtained after polymerization while minimizing the high-crystalline region in the molecule. In particular, the hydrogen gas may be preferably introduced in an amount of about 115 ppm or more or about 120 ppm or more in terms of decreasing hardness by reducing residual crystals of CPE under the same chlorination conditions and improving processability (comp'd MV) and size stability (plasticity) due to excellent dispersity in the CPE compound.

Meanwhile, when the hydrogen gas is introduced in an amount of more than 150 ppm, a wax content in a polymerization reaction solvent, e.g., hexane is increased. Thus, there may be a problem in that a particle aggregation phenomenon may occur during the chlorination reaction. Further, the wax content may be maintained at 20% or less in the polymerization process of the present disclosure, and the hydrogen input may be controlled. The wax content may be measured by separating the polymerization product using a centrifugal separator, sampling 100 mL of the remaining hexane solvent, settling for 2 hours, and determining a volume ratio occupied by the wax.

Further, the polymerization temperature may be about 25° C. to about 500° C., preferably about 25° C. to about 200° C., and more preferably about 50° C. to about 150° C. Further, the polymerization pressure may be about 1 kgf/cm² to about 100 kgf/cm², preferably about 1 kgf/cm² to about 50 kgf/cm², and more preferably about 5 kgf/cm² to about 30 kgf/cm².

The supported metallocene catalyst may be injected after being dissolved or diluted in a C₅ to C₁₂ aliphatic hydrocarbon solvent, such as pentane, hexane, heptane, nonane, decane and an isomer thereof, or in an aromatic hydrocarbon solvent, such as toluene and benzene, or in a hydrocarbon solvent substituted with chlorine, such as dichloromethane and chlorobenzene. The solvent used herein is preferably used after removing a small amount of water or air, which acts as a catalyst poison, by treating with a small amount of alkyl aluminum. It is also possible to further use the cocatalyst.

Meanwhile, according to still another embodiment of the present disclosure, provided is a chlorinated polyethylene (CPE) prepared using the above-described polyethylene.

The chlorinated polyethylene according to the present disclosure may be prepared by polymerizing ethylene in the presence of the supported metallocene catalyst described above, and then reacting the polyethylene with chlorine.

The reaction with chlorine may be carried out by dispersing the prepared polyethylene with water, an emulsifier and a dispersant, and then adding a catalyst and chlorine thereto.

The emulsifier may be polyether or polyalkylene oxide. The dispersant may be a polymer salt or an organic acid polymer salt, and the organic acid may be methacrylic acid or acrylic acid.

The catalyst may be a chlorination catalyst used in the art, and for example, benzoyl peroxide may be used. The chlorine may be used alone, or may be used in a mixture with an inert gas.

The chlorination reaction may be preferably performed at about 60° C. to about 150° C., or about 70° C. to about 145° C., or about 80° C. to about 140° C. and the reaction time may be preferably about 10 minutes to about 10 hours, about 1 hour to about 9 hours, or about 2 hours to about 8 hours.

The chlorinated polyethylene prepared by the above reaction may be further subjected to a neutralization process, a washing process, and/or a drying process, and thus may be obtained in a powder form.

Meanwhile, the chlorinated polyethylene according to the present disclosure may have low hardness and heat of fusion together with a specific Mooney viscosity by optimizing all of the melt index MI₅ and the melt flow rate ratio MFRR_{21.6/5} of polyethylene and the high-crystalline region in the molecular structure as described above, and therefore, during processing of a CPE compound to be applied to electric wires and cables, MV, processability, tensile strength, and plasticity as well as chlorination productivity in the chlorination process may be all improved in the excellent degree.

In particular, the chlorinated polyethylene exhibits excellent chlorine distribution uniformity in the chlorinated polyethylene due to the narrow molecular weight distribution of polyethylene. For example, the chlorinated polyethylene may have Mooney viscosity (MV) of about 50 or more to about 60 or less, as measured under condition of 121° C. after preparing the chlorinated polyethylene by reacting the polyethylene with chlorine in a slurry (water or aqueous HCl solution) at about 60° C. to about 150° C. Specifically, the chlorinated polyethylene may have Mooney viscosity (MV) of about 50.5 or more, or about 51 or more, or about 51.5 or more, or about 52 or more, and about 59 or less, or about 58 or less, or about 57 or less, or about 56 or less, or about 55 or less, or about 54 or less. In particular, the chlorinated polyethylene may have Mooney viscosity in the above-described range in terms of being mainly applied to thin electric wires and securing size stability during high-speed extrusion. Further, when the Mooney viscosity of the chlorinated polyethylene is too high, the surface of CPE compound processed for use in wires and cables by compounding with inorganic additives and cross-linking agents as described later may not be smooth and may be rough, and the gloss may be poor, resulting in a poor appearance.

In addition, the chlorinated polyethylene may have a tensile strength of about 12 MPa or more, or about 12 MPa to about 30 MPa, or about 12.5 MPa or more, or about 12.3 MPa to about 20 MPa, or about 12.5 MPa or more, or about 12.5 MPa to about 15 MPa, as measured in accordance with ASTM D 412. The chlorinated polyethylene may have a tensile elongation of about 500% or more or about 500% to about 2000%, or about 700% or more or about 700% to about 1500%, or about 900% or more or about 900% to about 1200%, as measured in accordance with ASTM D 412.

Specifically, the Mooney viscosity (MV), tensile strength and tensile elongation may be values measured for the chlorinated polyethylene obtained by heating about 500 kg to about 600 kg of polyethylene in a slurry (water or aqueous HCl solution) state from about 75° C. to about 85° C. to a final temperature of about 120° C. to about 140° C. at a rate of about 15° C./hr to about 18.5° C./hr, and then performing a chlorination reaction with gaseous chlorine at a final temperature of about 120° C. to about 140° C. for about 2 hours to about 5 hours. At this time, the chlorination reaction may be carried out by injecting the gaseous chlorine while raising the temperature and maintaining the pressure in the reactor at about 0.2 MPa to about 0.4 MPa at the same time, and a total input amount of chlorine may be about 650 kg to about 750 kg.

Further, the chlorinated polyethylene may have a hardness of about 50 or less or about 40 to about 50, or about 49 or less or about 40 to about 49, or about 48 or less or about 40 to about 48, or about 47 or less or about 41 to about 47, or about 46 or less or about 42 to about 46, or about 44 to about 46, as measured by Shore A in accordance with GB/T53. In particular, since the polyethylene of the present disclosure has the molecular structure, in which the high-crystalline region is optimized, hardness of the chlorinated polyethylene may be reduced, thereby improving processability.

Specifically, the hardness may be a value measured for the chlorinated polyethylene which is obtained by performing the same chlorination reaction as in measuring the Mooney viscosity (MV). For example, the hardness may be a value measured after processing the chlorinated polyethylene using a roll mill at 135° C. for 5 minutes, and then producing a sheet with a thickness of 6 mm at 140° C. using a press.

Further, the chlorinated polyethylene may have heat of fusion of 1.5 J/g or less, or about 0.1 J/g to about 1.5 J/g, or about 1.2 J/g or less, or about 0.2 J/g to about 1.2 J/g, or about 1.0 J/g or less, or about 0.3 J/g to about 1.0 J/g, or about 0.9 J/g or less, or about 0.4 J/g to about 0.9 J/g, or about 0.8 J/g or less, or about 0.4 J/g to about 0.8 J/g, or about 0.7 J/g to about 0.8 J/g. In particular, the heat of fusion of the chlorinated polyethylene represents the degree of residual crystals (DSC 1^{st} heating, 30° C. to 150° C. peak). As the residual crystals of the chlorinated polyethylene is lower, the hardness is lower and dispersity in the CPE compound is excellent, thereby improving processability (comp'd MV) and size stability (plasticity).

Specifically, the heat of fusion may be a value measured for the chlorinated polyethylene which is obtained by performing the same chlorination reaction as in measuring the Mooney viscosity (MV). Further, the heat of fusion may be measured using a differential scanning calorimeter (DSC, instrument name: DSC 2920, manufacturer: TA instrument). For example, heat flow data are obtained by heating DSC from −70° C. to 150° C. at a heating rate of 10° C. per min. At this time, the heat of fusion may be obtained by integrating peaks that appeared between 30° C. and 150° C. through a TA Universal Analysis program of TA instrument.

Methods of measuring Mooney viscosity (MV), hardness, and heat of fusion of the chlorinated polyethylene are as described in Test Example 2 to be described later, and detailed measurement methods are omitted herein.

For example, the chlorinated polyethylene may have a chlorine content of about 20% by weight to about 50% by weight, about 31% by weight to about 45% by weight, or about 35% by weight to about 40% by weight. Here, the chlorine content of the chlorinated polyethylene may be measured using combustion ion chromatography (Combustion IC, Ion Chromatography). For example, the combustion ion chromatography uses a combustion IC (ICS-5000/AQF-2100H) device equipped with an IonPac AS18 (4×250 mm) column. The chlorine content may be measured using KOH (30.5 mM) as an eluent at a flow rate of 1 mL/min at an inlet temperature of 900° C. and an outlet temperature of 1000° C. The device conditions and measurement conditions for measuring the chlorine content are as described in Test Example 2 to be described later, the detailed description is omitted.

Specifically, the chlorinated polyethylene according to the present disclosure may have a Mooney viscosity (MV) of about 65 to about 80, a tensile strength of about 12.5 MPa or more or about 12.5 MPa to about 15 MPa, and a tensile elongation of about 900% or more or about 900% to about 1200% under a condition where the chlorine content is 35% by weight to 40% by weight.

The chlorinated polyethylene may be, for example, a randomly chlorinated polyethylene.

The chlorinated polyethylene prepared according to the present disclosure is excellent in chemical resistance, weather resistance, flame retardancy, or processability, and the like, and is widely applied to electric wires or cables, and the like.

Meanwhile, according to still another embodiment of the present disclosure, provided is a chlorinated polyethylene (CPE) compound including the above-described chlorinated polyethylene.

In particular, the chlorinated polyethylene (CPE) compound of the present disclosure is characterized by showing very excellent mechanical properties while minimizing deterioration of processability even during high-speed extrusion by optimizing all of the entanglement molecular weight (Me) and the melt flow rate ratio (MFRR_{21.6/5}) of polyethylene and achieving high degree of crosslinking due to a narrow molecular weight distribution.

The chlorinated polyethylene (CPE) compound is mainly applied to electric wires and cables, and has excellent characteristics in processability, surface appearance and gloss of a molded article, and tensile strength for cross-linked compound.

The chlorinated polyethylene (CPE) compound may include about 1% by weight to about 80% by weight, about 10% by weight to about 70% by weight, about 20% by weight to about 60% by weight of the chlorinated polyethylene prepared by the method as described above.

For example, the chlorinated polyethylene (CPE) compound may include 100 parts by weight to 280 parts by weight of an inorganic additive such as talc and carbon black and 1 part by weight to 40 parts by weight of a crosslinking agent, based on 100 parts by weight of the chlorinated polyethylene.

For a specific example, the chlorinated polyethylene (CPE) compound may include 25% by weight to 50% by weight of the chlorinated polyethylene, 50% by weight to 70% by weight of an inorganic additive such as talc and carbon black, and 0.5% by weight to 10% by weight of a crosslinking agent.

The chlorinated polyethylene (CPE) compound is prepared with an inorganic additive (for example, talc, or carbon black, and the like), a plasticizer, and a cross-linking agent, and crosslinked at 140° C. to 200° C., followed by measuring a Mooney viscosity (MV) of the chlorinated polyethylene (CPE) compound at 100° C. using a Mooney viscometer. The Mooney viscosity may be about 30 or more to about 48. Specifically, the chlorinated polyethylene (CPE) compound may have Mooney viscosity (MV) of about 32 or more, or about 34 or more, or about 33 or more, or about 37 or more, or about 37.5 or more, or about 38 or more, or about 38.5 or more, and about 45 or less, or about 46 or less, or about 43 or less, or about 41.5 or less, or about 40 or less, or about 39.5 or less, or about 39.2 or less. Further, the chlorinated polyethylene (CPE) compound may have a tensile strength of about 9.2 MPa or more or about 9.2 MPa to about 30 MPa, or about 9.4 MPa or more or about 9.4 MPa to about 20 MPa, or about 9.5 MPa or more or about 9.5 MPa to about 15 MPa, or about 9.5 MPa to about 12 MPa, or about 9.5 MPa to about 10 MPa, as measured in accordance with ASTM D 412. The chlorinated polyethylene (CPE) compound may have a tensile elongation of about 500% or more or about 500% to about 1000%, or about 505% or more or about 505% to about 800%, or about 510% or more or about 510% to about 600%, or about 515% or more or about 515% to about 550%, or about 520% or more or about 520% to about 530%, as measured in accordance with ASTM D 412.

Further, the chlorinated polyethylene (CPE) compound may have a plasticity (%) of about 42% or more or about 42% to about 65%, or about 43% or more or about 43% to about 60%, or about 44% or more or about 44% to about 55%, or about 44% to about 45.2%, or about 44% to about 44.6%, as measured in accordance with ASTM D 926. The plasticity is a property, in which an object, whose shape has been changed by an external force, does not return to its original shape even when the external force is removed. As the plasticity is higher, the processability and size stability are more improved. The chlorinated polyethylene (CPE) compound may have a plasticity of 42% or more in terms of realizing excellent extrusion size stability while ensuring excellent extrusion processing when processing for cable wires.

Specifically, the plasticity of the chlorinated polyethylene (CPE) compound may be measured at 70° C. under a load of 5 kg.

For example, the plasticity of the chlorinated polyethylene (CPE) compound is determined as follows: a CPE compound specimen with a height of 10 mm and a diameter of 16 mm (height h₀ of the specimen) is measured at 70° C. under a load of 5 kg, and preheated at 70° C. for 3 minutes. A load of 5 kg is applied and a height (h₁) of the deformed specimen is measured. Then, the load is removed, and after 3 minutes at room temperature, a height (h₂) of the recovered specimen is measured. The plasticity (%) of the CPE compound is calculated according to Equation 1 below.

P=(h₀−h₂)/(h₀+h₁) [Equation 1]

in Equation 1,

P represents plasticity (%) of a CPE compound,

h₀ represents a height (mm) of a specimen before deformation when measuring plasticity,

h₁ represents a height (mm) of the specimen deformed by preheating at 70° C. for 3 minutes and applying a load of 5 kg, and

h₂ represents a height (mm) of the specimen measured after 3 minutes at room temperature after removing the load.

In addition, a method of manufacturing a molded article using the chlorinated polyethylene according to the present disclosure may be performed by applying a traditional method in the art. For example, the molded article may be manufactured by roll-mill compounding the chlorinated polyethylene and extruding it.

Hereinafter, preferred examples will be provided for better understanding of the present invention. However, the following examples are provided only for understanding the present invention more easily, but the content of the present invention is not limited thereby.

### EXAMPLE

[Preparation of Catalyst Precursor]

### Synthesis Example 1: Preparation of First Metallocene Compound

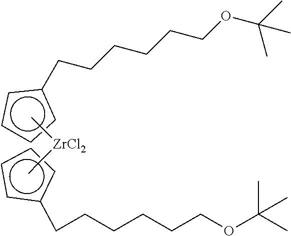

t-butyl-O—(CH₂)₆—Cl was prepared by a method described in a literature (Tetrahedron Lett. 2951(1988)) using 6-chlorohexanol, and reacted with cyclopentadienyl sodium (NaCp) to obtain t-butyl-O—(CH₂)₆—C₅H₅ (yield 60%, b.p. 80° C./0.1 mmHg).

Further, t-butyl-O—(CH₂)₆—C₅H₅ was dissolved in tetrahydrofuran (THF) at −78° C., and n-butyllithium (n-BuLi) was slowly added thereto. Thereafter, the mixture was heated to room temperature and allowed to react for 8 hours. The lithium salt solution synthesized as described above was slowly added to a suspension solution of ZrCl₄(THF)₂ (170 g, 4.50 mmol)/THF (30 mL) at −78° C., and further reacted for 6 hours at room temperature. All volatiles were removed by drying under vacuum and the resulting oily liquid material was filtered by adding hexane. The filtered solution was dried under vacuum, and hexane was added to obtain a precipitate at a low temperature (−20° C.). The obtained precipitate was filtered at a low temperature to obtain [t-butyl-O—(CH₂)₆—C₅H₄]₂ZrCl₂] in the form of a white solid (yield 92%).

¹H-NMR (300 MHz, CDCl₃): 6.28 (t, J=2.6 Hz, 2H), 6.19 (t, J=2.6 Hz, 2H), 3.31 (t, 6.6 Hz, 2H), 2.62 (t, J=8 Hz), 1.7-1.3 (m, 8H), 1.17 (s, 9H).

¹³C-NMR (CDCl₃): 135.09, 116.66, 112.28, 72.42, 61.52, 30.66, 30.31, 30.14, 29.18, 27.58, 26.00.

### Synthesis Example 2: Preparation of Second Metallocene Compound

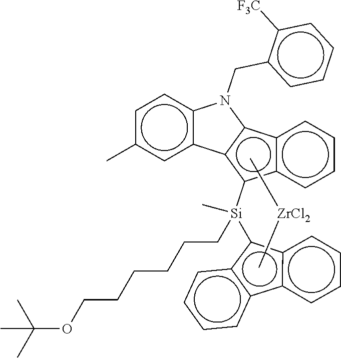

2-1 Preparation of Ligand Compound

2.9 g (7.4 mmol) of 8-methyl-5-(2-(trifluoromethyl)benzyl)-5,10-dihydroindeno[1,2-b]indole was dissolved in 100 mL of hexane and 2 mL (16.8 mmol) of methyl tertiary butyl ether (MTBE), and 3.2 mL (8.1 mmol) of 2.5 M n-butyllithium (n-BuLi) hexane solution was added dropwise in a dry ice/acetone bath and stirred at room temperature overnight. In another 250 mL schlenk flask, 2 g (7.4 mmol) of (6-tert-butoxyhexyl)dichloro(methyl)silane was dissolved in 50 mL of hexane and added dropwise in a dry ice/acetone bath. Then, a lithiated slurry of 8-methyl-5-(2-(trifluoromethyl)benzyl)-5,10-dihydroindeno[1,2-b]indole was added dropwise through a cannula. After the injection, the mixture was slowly heated to room temperature and then stirred at room temperature overnight. At the same time, 1.2 g (7.4 mmol) of fluorene was also dissolved in 100 mL of tetrahydrofuran (THF), and 3.2 mL (8.1 mmol) of 2.5 M n-BuLi hexane solution was added dropwise in a dry ice/acetone bath, followed by stirring at room temperature overnight.

The reaction solution (Si solution) of 8-methyl-5-(2-(trifluoromethyl)benzyl)-5,10-dihydroindeno[1,2-b]indole and (6-(tert-butoxy)hexyl)dichloro(methyl)silane was confirmed by NMR sampling.

¹H NMR (500 MHz, CDCl₃): 7.74-6.49 (11H, m), 5.87 (2H, s), 4.05 (1H, d), 3.32 (2H, m), 3.49 (3H, s), 1.50-1.25 (8H, m), 1.15 (9H, s), 0.50 (2H, m), 0.17 (3H, d).

After confirming the synthesis, the lithiated solution of fluorene was slowly added dropwise to the Si solution in a dry ice/acetone bath, and stirred at room temperature overnight. After the reaction, it was extracted with ether/water and residual moisture of the organic layer was removed with MgSO₄. Then, the solvent was removed under vacuum reduced pressure to obtain 5.5 g (7.4 mmol) of an oily ligand compound, which was confirmed by ¹H-NMR.

¹H NMR (500 MHz, CDCl₃): 7.89-6.53 (19H, m), 5.82 (2H, s), 4.26 (1H, d), 4.14-4.10 (1H, m), 3.19 (3H, s), 2.40 (3H, m), 1.35-1.21 (6H, m), 1.14 (9H, s), 0.97-0.9 (4H, m), −0.34 (3H, t).

2-2 Preparation of Metallocene Compound

5.4 g (Mw 742.00, 7.4 mmol) of the ligand compound synthesized in 2-1 was dissolved in 80 mL of toluene and 3 mL (25.2 mmol) of MTBE, and 7.1 mL (17.8 mmol) of 2.5 M n-BuLi hexane solution was added dropwise in a dry ice/acetone bath, followed by stirring at room temperature overnight. 3.0 g (8.0 mmol) of ZrCl₄(THF)₂ was added to 80 mL of toluene to prepare a slurry. 80 mL of the toluene slurry of ZrCl₄(THF)₂ was transferred to a ligand-Li solution in a dry ice/acetone bath and stirred at room temperature overnight.

After the reaction mixture was filtered to remove LiCl, the toluene of the filtrate was removed by drying under vacuum, and then 100 mL of hexane was added thereto, followed by sonication for 1 hour. This was filtered to obtain 3.5 g (yield 52 mol %) of a purple metallocene compound as a filtered solid.

¹H NMR (500 MHz, CDCl₃): 7.90-6.69 (9H, m), 5.67 (2H, s), 3.37 (2H, m), 2.56 (3H, s), 2.13-1.51 (11H, m), 1.17 (9H, s).

### Synthesis Example 3: Preparation of Second Metallocene Compound

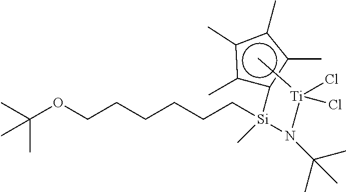

50 g of Mg (s) was added to a 10 L reactor at room temperature, followed by adding 300 mL of THF. 0.5 g of 12 was added, and the reactor temperature was maintained at 50° C. After the reactor temperature was stabilized, 250 g of 6-t-butoxyhexyl chloride was added to the reactor at a rate of 5 mL/min using a feeding pump. It was observed that the reactor temperature was increased by 4° C. to 5° C. with the addition of 6-t-butoxyhexylchloride. It was stirred for 12 hours while continuously adding 6-t-butoxyhexylchloride to obtain a black reaction solution. 2 mL of the black solution was taken to which water was added to obtain an organic layer. The organic layer was confirmed to be 6-t-butoxyhexane through ¹HNMR, indicating that Grignard reaction occurred well. Consequently, 6-t-butoxyhexyl magnesium chloride was synthesized.

500 g of MeSiCl₃ and 1 L of THF were introduced to a reactor, and then the reactor temperature was cooled down to −20° C. 560 g of the 6-t-butoxyhexyl magnesium chloride synthesized above was added to the reactor at a rate of 5 mL/min using a feeding pump. After completion of the feeding of Grignard reagent, the mixture was stirred for 12 hours while slowly raising the reactor temperature to room temperature. Then, it was confirmed that white MgCl₂ salt was produced. 4 L of hexane was added thereto and the salt was removed through a labdori to obtain a filtered solution. After the filtered solution was added to the reactor, hexane was removed at 70° C. to obtain a pale yellow liquid. The obtained liquid was confirmed to be methyl(6-t-butoxyhexyl)dichlorosilane through ¹H-NMR.

¹H-NMR (CDCl₃): 3.3 (t, 2H), 1.5 (m, 3H), 1.3 (m, 5H), 1.2 (s, 9H), 1.1 (m, 2H), 0.7 (s, 3H)

1.2 mol (150 g) of tetramethylcyclopentadiene and 2.4 L of THF were added to the reactor, and then the reactor temperature was cooled down to −20° C. 480 mL of n-BuLi was added to the reactor at a rate of 5 ml/min using a feeding pump. After n-BuLi was added, the mixture was stirred for 12 hours while slowly raising the reactor temperature to room temperature. Then, an equivalent of methyl(6-t-butoxyhexyl)dichlorosilane (326 g, 350 mL) was rapidly added to the reactor. The mixture was stirred for 12 hours while slowly raising the reactor temperature to room temperature. Then, the reactor temperature was cooled to 0° C. again, and 2 equivalents of t-BuNH₂ was added. The mixture was stirred for 12 hours while slowly raising the reactor temperature to room temperature. Then, THF was removed. Thereafter, 4 L of hexane was added and the salt was removed through a labdori to obtain a filtered solution. The filtered solution was added to the reactor again, and hexane was removed at 70° C. to obtain a yellow solution. The yellow solution obtained above was confirmed to be methyl(6-t-butoxyhexyl)(tetramethylCpH)t-butylaminosilane through ¹H-NMR.

TiCl₃(THF)₃ (10 mmol) was rapidly added to a dilithium salt of a ligand at −78° C., which was synthesized from n-BuLi and the ligand of dimethyl(tetramethylCpH)t-butylaminosilane in THF solution. While slowly heating the reaction solution from −78° C. to room temperature, it was stirred for 12 hours. Then, an equivalent of PbCl₂ (10 mmol) was added to the reaction solution at room temperature, and then stirred for 12 hours to obtain a dark black solution having a blue color. After removing THF from the resulting reaction solution, hexane was added to filter the product. Hexane was removed from the filtered solution, and then the product was confirmed to be [tBu-O—(CH₂)₆](CH₃)Si(C₅(CH₃)₄)(tBu-N)TiCl₂] through ¹H-NMR.

¹H-NMR (CDCl₃): 3.3 (s, 4H), 2.2 (s, 6H), 2.1 (s, 6H), 1.8-0.8 (m), 1.4 (s, 9H), 1.2 (s, 9H), 0.7 (s, 3H).

[Preparation of Supported Catalyst]

### Preparation Example 1: Preparation of Supported Catalyst

5.0 kg of a toluene solution was put in a 20 L stainless steel (sus) high-pressure reactor, and the reactor temperature was maintained at 40° C. 1000 g of silica (SP948, manufactured by Grace Davison Co.) dehydrated at a temperature of 600° C. for 12 hours under vacuum was added to the reactor, and the silica was sufficiently dispersed, and then 84 g of the metallocene compound of Synthesis Example 1 dissolved in toluene was added thereto and then allowed to react under stirring at 200 rpm at 40° C. for 2 hours. Thereafter, the stirring was stopped, followed by settling for 30 minutes and decantation of the reaction solution.

2.5 kg of toluene was added to the reactor, and 9.4 kg of 10 wt % methylaluminoxane (MAO)/toluene solution was added thereto, followed by stirring at 200 rpm at 40° C. for 12 hours. After the reaction, the stirring was stopped, followed by settling for 30 minutes and decantation of the reaction solution. 3.0 kg of toluene was added and stirred for 10 minutes, and then the stirring was stopped, followed by settling for 30 minutes and decantation of the toluene solution.

3.0 kg of toluene was added to the reactor, 116 g of the metallocene compound of Synthesis Example 2 dissolved in 1 L of a toluene solution was added thereto, and allowed to react under stirring at 200 rpm at 40° C. for 2 hours. At this time, the metallocene compound of Synthesis Example 1 and the metallocene compound of Synthesis Example 2 were used at a molar ratio of 42:58. After lowering the reactor temperature to room temperature, the stirring was stopped, followed by settling for 30 minutes and decantation of the reaction solution.

2.0 kg of toluene was added to the reactor and stirred for 10 minutes. Then, the stirring was stopped, followed by settling for 30 minutes and decantation of the reaction solution.

3.0 kg of hexane was added to the reactor, a hexane slurry was transferred to a filter drier, and the hexane solution was filtered. 1 kg-SiO₂ supported hybrid catalyst was prepared by drying under reduced pressure at 40° C. for 4 hours.

### Comparative Preparation Example 1: Preparation of Supported Catalyst

A supported hybrid catalyst was prepared in the same manner as in Preparation Example 1, except that the ratio of the metallocene compound of Synthesis Example 1 and the metallocene compound of Synthesis Example 2 was changed to 35:65, based on the weight.

### Comparative Preparation Example 2: Preparation of Supported Catalyst

A supported hybrid catalyst was prepared in the same manner as in Preparation Example 1, except that the ratio of the metallocene compound of Synthesis Example 1 and the metallocene compound of Synthesis Example 2 was changed to 60:40, based on the weight.

### Comparative Preparation Example 3: Preparation of Supported Catalyst

A supported hybrid catalyst was prepared in the same manner as in Preparation Example 1, except that the metallocene compound of Synthesis Example 3 was used instead of the metallocene compound of Synthesis Example 2.

[Preparation of Polyethylene]

### Example 1-1

The supported catalyst prepared in Preparation Example 1 was added to a single slurry polymerization process to prepare a high-density polyethylene.

First, a reactor with a capacity of 100 m³ was charged with a flow rate of 25 ton/hr of hexane, 10 ton/hr of ethylene, 120 ppm of hydrogen (relative to ethylene), and 10 kg/hr of triethylaluminum (TEAL), and the supported hybrid metallocene catalyst of Preparation Example 1 was injected to the reactor at 0.5 kg/hr. Thereafter, the ethylene was continuously reacted in a hexane slurry state at a reactor temperature of 82° C. and a pressure of 7.0 kg/cm² to 7.5 kg/cm². Then, solvent removal and drying processes were performed to prepare a high-density polyethylene in a powder form.

### Example 1-2

A high-density polyethylene was prepared in a powder form in the same manner as in Example 1-1, except that the hydrogen input amount was changed to 125 ppm.

### Example 1-3

A high-density polyethylene was prepared in a powder form in the same manner as in Example 1-1, except that the hydrogen input amount was changed to 130 ppm.

### Comparative Example 1-1

A high-density polyethylene (HDPE) commercial product (Z/N-1, CE2030K, manufactured by LG Chem), which was prepared using a Ziegler-Natta catalyst, and of which MI₅ (melt index, as measured at 190° C. under a load of 5 kg) was 1.7 g/10 min, was prepared for Comparative Example 1-1.

### Comparative Example 1-2

A high-density polyethylene (HDPE) commercial product (Z/N-2, CE2080, manufactured by LG Chem), which was prepared using a Ziegler-Natta catalyst, and of which MI₅ (melt index, as measured at 190° C. under a load of 5 kg) was 1.2 g/10 min, was prepared for Comparative Example 1-2.

### Comparative Example 1-3

A high-density polyethylene (HDPE) pilot product (Z/N-3, manufactured by LG Chem), which was prepared using a Ziegler-Natta catalyst, and of which MI₅ (melt index, as measured at 190° C. under a load of 5 kg) was 1.5 g/10 min, was prepared for Comparative Example 1-3.

### Comparative Example 1-4

A high-density polyethylene of Comparative Example 1-4 was prepared in a powder form in the same manner as in Example 1-2, except that the supported catalyst prepared in Comparative Preparation Example 1 was used instead of the supported catalyst prepared in Preparation Example 1.

### Comparative Example 1-5

A high-density polyethylene of Comparative Example 1-5 was prepared in a powder form in the same manner as in Example 1-2, except that the supported catalyst prepared in Comparative Preparation Example 2 was used instead of the supported catalyst prepared in Preparation Example 1.

### Comparative Example 1-6

A high-density polyethylene of Comparative Example 1-6 was prepared in a powder form in the same manner as in Example 1-1, except that the supported catalyst prepared in Comparative Preparation Example 3 was used instead of the supported catalyst prepared in Preparation Example 1.

### Test Example 1

Physical properties of the polyethylenes prepared in Examples 1-1 to 1-3 and Comparative Examples 1-1 to 1-6 were measured by the following methods, and the results are shown in Table 1 below.

1) Melt Index (MI, g/10 min):

The melt index (MI_{2.16}, MI₅, MI_{21.6}) was measured under a load of 2.16 kg, 5 kg, and 21.6 kg, respectively, in accordance with the ASTM D 1238 method at a temperature of 190° C. A weight (g) of the polymer melted for 10 minutes was recorded as the melt index.

2) Melt Flow Rate Ratio (MFRR):

The melt flow rate ratio (MFRR, MI_{21.6/5}) was obtained by dividing the melt index measured at 190° C. under a load of 21.6 kg by the melt index measured at 190° C. under a load of 5 kg in accordance with ASTM D 1238.

3) Density:

The density (g/cm³) of each polyethylene was measured in accordance with the ASTM D 1505 method.

4) High-Crystalline Region Ratio (%):

A temperature rising elution fractionation (TREF) graph for polyethylene was obtained, and an elution temperature of 105° C. on the TREF graph was used as a reference for the vertical axis at which the high-crystalline region starts. Then, a graph area of the high-crystalline region having a temperature equal to or higher than the elution temperature of 105° C. was measured, and a percentage value obtained by dividing the graph area by a total graph area was expressed as the high-crystalline region ratio (%). Here, the temperature rising elution fractionation (TREF) graph for polyethylene was obtained using Agilent Technologies 7890A manufactured by Polymer Char. In more detail, a polyethylene sample was dissolved in 20 mL of 1,2,4-trichlorobenzene at a concentration of 1.5 mg/mL, and then dissolved by increasing the temperature at a rate of 40° C./min from 30° C. to 150° C., recrystallized by lowering the temperature at a rate of 0.5° C./min to 35° C., and then eluted by increasing the temperature at a rate of 1° C./min to 140° C. to obtain the graph.

5) Molecular Weight Distribution (MWD, Polydispersity Index):

The molecular weight distribution (MWD) was determined by measuring a weight average molecular weight (Mw) and a number average molecular weight (Mn) of the polyethylene using gel permeation chromatography (GPC, manufactured by Water), and then dividing the weight average molecular weight by the number average molecular weight.

In particular, Waters PL-GPC220 was used as the gel permeation chromatography (GPC) instrument, and a Polymer Laboratories PLgel MIX-B 300 mm length column was used. In this regard, the measurement temperature was 160° C., and 1,2,4-trichlorobenzene was used as a solvent, and a flow rate of 1 mL/min was applied. The polyethylene samples according to Examples and Comparative Examples were pretreated by dissolving in 1,2,4-trichlorobenzene containing 0.0125% of BHT at 160° C. for 10 hours using a GPC analyzer (PL-GP220), and each sample was prepared at a concentration of 10 mg/10 mL, and then was supplied in an amount of 200 μL. Mw and Mn values were obtained using a calibration curve formed using polystyrene standards. 9 kinds of polystyrene standards were used, the polystyrene standards having a weight average molecular weight of 2000 g/mol, 10000 g/mol, 30000 g/mol, 70000 g/mol, 200000 g/mol, 700000 g/mol, 2000000 g/mol, 4000000 g/mol, 10000000 g/mol.

TABLE 1

| | Example | | | Comparative Example | | | | | |
|---|---|---|---|---|---|---|---|---|---|
| | 1-1 | 1-2 | 1-3 | 1-1 | 1-2 | 1-3 | 1-4 | 1-5 | 1-6 |
| Catalyst | Preparation | Preparation | Preparation | Z/N-1 | Z/N-2 | Z/N-3 | Comparative | Comparative | Comparative |
| | Example 1 | Example 1 | Example 1 | | | | Preparation | Preparation | Preparation |
| | | | | | | | Example 1 | Example2 | Example 3 |
| H₂ input (ppm) | 120 | 125 | 130 | — | — | — | 230 | 80 | 120 |
| during polymerization | | | | | | | | | |
| MI_{2.16} (2.16 kg, | 0.30 | 0.31 | 0.32 | 0.41 | 0.32 | 0.30 | 0.34 | 0.15 | 0.85 |
| 190° C., g/10 min) | | | | | | | | | |
| MI₅ (5 kg, | 1.1 | 1.3 | 1.4 | 1.7 | 1.2 | 1.5 | 1.5 | 0.6 | 3.0 |
| 190° C., g/10 min) | | | | | | | | | |
| MFRR (21.6/5) | 19 | 19.5 | 20 | 17.5 | 15.6 | 17.2 | 22 | 16 | 10.5 |
| Density (g/cm³) | 0.957 | 0.958 | 0.959 | 0.958 | 0.958 | 0.957 | 0.959 | 0.955 | 0.955 |
| High-crystalline | 7.6 | 7.7 | 7.8 | 18 | 11.2 | 7.9 | 8.2 | 7.5 | 5.3 |
| region ratio | | | | | | | | | |
| (wt %, TREF, | | | | | | | | | |
| 105° C. or higher) | | | | | | | | | |
| Mw (×10³ g/mol) | 153 | 150 | 147 | 175 | 180 | 177 | 146 | 179 | 93 |
| Molecular weight | 7.2 | 7.4 | 7.6 | 15.5 | 9.1 | 15.2 | 8.6 | 6.4 | 3.9 |
| distribution (Mw/Mn) | | | | | | | | | |

In Table 1, the H₂ input amount (ppm) during polymerization represents a hydrogen gas content, based on the ethylene input amount.

As shown in Table 1, as compared with Comparative Examples, Examples showed that CPE had optimized MV of 50 to 60 due to MI, MFRR, and molecular structure, thereby exhibiting excellent mechanical properties such as tensile strength, together with excellent extrusion processability and size stability even during a high-speed extrusion process when applied to electric wires or cables, and the like.

### Test Example 2

The polyethylenes prepared in Examples 1-1 to 1-3 and Comparative Examples 1-1 to 1-6 were used to prepare chlorinated polyethylenes, respectively.

[Preparation of Chlorinated Polyethylene]

5000 L of water and 550 kg of high-density polyethylene prepared in Example 1-1 were added to a reactor, and then sodium polymethacrylate as a dispersant, oxypropylene and oxyethylene copolyether as an emulsifier, and benzoyl peroxide as a catalyst were added thereto. Then, the temperature was raised from 80° C. to 132° C. at a rate of 17.3° C./hr and chlorination was carried out by injecting gaseous chlorine at a final temperature of 132° C. for 3 hours. At this time, the chlorination reaction was performed by injecting the gaseous chlorine at a reactor pressure of 0.3 MPa while raising the temperature, and a total input of chlorine was 610 kg. The chlorinated reactant was neutralized with NaOH for 4 hours, washed again with running water for 4 hours, and finally dried at 120° C. to prepare a chlorinated polyethylene in a powder form.

In the same manner, each of the polyethylenes prepared in Examples 1-2 to 1-3 and Comparative Examples 1-1 to 1-6 was also used to prepare each chlorinated polyethylene in a powder form.

Physical properties were measured by the following methods for the chlorinated polyethylenes of Examples 2-1 to 2-3 and Comparative Examples 2-1 to 2-6 prepared by using the polyethylenes prepared in Examples 1-1 to 1-3 and Comparative Examples 1-1 to 1-6, respectively. The results are shown in Table 2, below.

1) Mooney Viscosity (MV) of CPE:

A rotor in a Mooney viscometer was wrapped with a CPE sample and a die was closed. After preheating to 121° C. for 1 min, the rotor was rotated for 4 min to measure Mooney viscosity (MV, 121° C., ML1+4).

2) Hardness of CPE:

Hardness of CPE was measured by Shore A in accordance with GB/T53. In particular, a chlorinated polyethylene (CPE) powder product was treated with a roll mill at 135° C. for 5 minutes, and a sheet with a thickness of 6 mm was manufactured by a press at 140° C., and used to measure hardness by Shore A in accordance with GB/T53.

3) Heat of Fusion (J/g) of CPE:

The heat of fusion of CPE was measured using a differential scanning calorimeter (DSC, instrument name: DSC 2920, manufacturer: TA instrument).

In particular, the heat of fusion (J/g) represents the degree of residual crystals (DSC 1^{st} heating, 30° C. to 50° C. peak), and heat flow data are obtained by heating DSC from −70° C. to 150° C. at a heating rate of 10° C. per min. At this time, the heat of fusion was obtained by integrating peaks that appeared between 30° C. and 150° C. through a TA Universal Analysis program of TA instrument. At this time, temperature was increased or decreased at a rate of 10° C./min, and the heat of fusion was determined by the result measured in the 1^{st} heating cycle.

TABLE 2

| | Example | | | Comparative Example | | | | | |
|---|---|---|---|---|---|---|---|---|---|
| | 2-1 | 2-2 | 2-3 | 2-1 | 2-2 | 2-3 | 2-4 | 2-5 | 2-6 |
| MV (121° C., ML1 + 4) of CPE | 54 | 53 | 52 | 57 | 72 | 53 | 45 | 65 | 53 |
| Hardness (Shore A) of CPE | 46 | 45 | 44 | 49 | 48 | 50 | 45 | 46 | 52 |
| Heat of fusion (J/g) of CPE | 0.8 | 0.7 | 0.8 | 14.4 | 4.9 | 2.2 | 1 | 0.8 | 20.5 |

As shown in Table 2, as compared with Comparative Examples, Examples showed that Mooney viscosity (MV) of CPE was 52 to 54 and the heat of fusion was 0.7 J/g to 0.8 J/g, and residual crystals (DSC 1^{st} heating, 30° C. to 150° C. peak) were small and thus chlorine distribution was uniform, and therefore, hardness was as low as 44 to 46. In particular, as compared with Comparative Example 2-3 having MV equivalent to those of Examples, Examples 2-1 and 2-3 showed that the heat of fusion of CPE was lower by about 63%, and Example 2-2 showed that the heat of fusion of CPE was lower by about 68%, indicating that excellent processability was achieved. Further, since Comparative Example 2-6 had a low high-crystalline region ratio, its hardness or heat of fusion should be low. However, the molecular weight of the polyethylene was too low, and thus hardness and heat of fusion were remarkably increased, and chlorination productivity was greatly reduced, and the uniform chlorination reaction did not properly occur.

### Test Example 3

25% by weight to 50% by weight of the chlorinated polyethylenes prepared using the polyethylenes prepared in Examples 1-1 to 1-3 and Comparative Examples 1-1 to 1-5, and 50% by weight to 70% by weight of an inorganic additive, such as talc, or carbon black, and the like, and 0.5% by weight to 10% by weight of a crosslinking agent were compounded and processed to prepare CPE compound specimens of Examples 3-1 to 3-3 and Comparative Examples 3-1 to 3-5, respectively.

Physical properties were measured by the following methods for the CPE compounds of Examples 3-1 to 3-3 and Comparative Examples 3-1 to 3-5 including the chlorinated polyethylenes prepared using the polyethylenes of Examples 1-1 to 1-3 and Comparative Examples 1-1 to 1-5 as described above, and the results are shown in Table 3 below.

1) Mooney Viscosity (MV) of CPE Compound:

A rotor in an MV instrument was wrapped with a CPE compound sample and a die was closed. After preheating to 100° C. for 1 min, the rotor was rotated for 4 min to measure Mooney viscosity (MV, 100° C., ML1+4).

2) Tensile Strength (MPa) and Tensile Elongation (%) of CPE Compound:

The tensile strength (MPa) and the tensile elongation (%) of the CPE compounds were measured under a condition of 500 mm/min in accordance with ASTM D 412.

3) Plasticity (%) of CPE Compound:

The plasticity (%) of the CPE compounds was measured under conditions of 70° C. and a load of 5 kg in accordance with ASTM D 926.

In particular, the CPE compound specimen with a height of 10 mm and a diameter of 16 mm (height h₀ of the specimen) was measured at 70° C. under a load of 5 kg, and preheated at 70° C. for 3 minutes. A load of 5 kg was applied and a height (h₁) of the deformed specimen was measured. Then, the load was removed, and after 3 minutes at room temperature, a height (h₂) of the recovered specimen was measured. The plasticity (%) of the CPE compound is calculated according to Equation 1 below.

P=(h₀−h₂)/(h₀+h₁) [Equation 1]

in Equation 1,

P represents plasticity (%) of a CPE compound,

h₀ represents a height (mm) of a specimen before deformation when measuring plasticity,

h₁ represents a height (mm) of the specimen deformed by preheating at 70° C. for 3 minutes and applying a load of 5 kg, and

h₂ represents a height (mm) of the specimen measured after 3 minutes at room temperature after removing the load.

TABLE 3

| | Example | | | Comparative Example | | | | |
|---|---|---|---|---|---|---|---|---|
| | 3-1 | 3-2 | 3-3 | 3-1 | 3-2 | 3-3 | 3-4 | 3-5 |
| MV (100° C., ML1 + 4) of CPE compound | 39.2 | 38.9 | 38.5 | 40.7 | 55.8 | 41.6 | 34.6 | 50 |
| Tensile strength (MPa) of CPE compound | 10 | 10 | 9.5 | 9 | 12 | 9 | 9 | 10 |
| Tensile elongation (%) of CPE compound | 520 | 520 | 530 | 490 | 480 | 490 | 530 | 520 |
| Plasticity (%) of CPE compound | 44.3 | 44.6 | 44.1 | 36.7 | 38.5 | 40.3 | 41.9 | 45.8 |

As shown in Table 3, as compared with Comparative Examples, Examples showed that CPE compounds had MV (Mooney viscosity) of 38.5 to 39.2, very excellent tensile strength and elongation of 9.5 MPa to 10 MPa and 520% to 530%, and very excellent plasticity of 44.1% to 44.6%. Therefore, Examples according to the present disclosure were found to have a balanced product specification in terms of chloride productivity, MV, processability, tensile strength, and plasticity.

In contrast, the CPE compounds of Comparative Examples 3-1, 3-3, and 3-4 had low tensile strength, and may have poor mechanical properties, when processed into electric wires and cables. In particular, the CPE compound of Comparative Example 3-4 had low CPE MV, and thus its tensile strength was reduced, and the CPE compounds of Comparative Examples 3-2 and 3-5 had high CPE MV, and thus may have reduced extrusion processability during a high-speed extrusion process when applied to electric wires or cables, and the like.

1. A polyethylene, having
a MI₅, which is a melt index measured at 190° C. under a load of 5 kg of 0.8 g/10 min to 1.4 g/10 min,
a melt flow rate ratio MFRR_{21.6/5}, which is a value obtained by dividing the melt index measured at 190° C. under a load of 21.6 kg by the melt index measured at 190° C. under a load of 5 kg in accordance with ASTM D 1238, is 18 to 22, and
a high-crystalline region ratio on a temperature rising elution fractionation (TREF) graph is 10% or less, wherein the high-crystalline region ratio is a percentage value obtained by dividing a graph area of the high-crystalline region at an elution temperature of 105° C. or higher by a total graph area.

2. The polyethylene according to claim 1, wherein the polyethylene is an ethylene homopolymer.

3. The polyethylene according to claim 1, which has a MI_{2.16}, which is a melt index measured at 190° C. under a load of 2.16 kg, of 0.01 g/10 min to 0.45 g/10 min.

4. The polyethylene according to claim 1, wherein the high-crystalline region ratio is 3% to 10%.

5. The polyethylene according to claim 1, which has a density of 0.955 g/cm³ to 0.960 g/cm³.

6. The polyethylene according to claim 1, which has a molecular weight distribution Mw/Mn of 5 to 10.

7. The polyethylene according to claim 1, which has a weight average molecular weight of 110000 g/mol to 250000 g/mol.

8. A process for preparing the polyethylene according to claim 1, comprising the step of polymerizing ethylene in the presence of at least one first metallocene compound represented by the following Chemical Formula 1; and at least one second metallocene compound selected from compounds represented by the following Chemical Formula 2, wherein a weight ratio of the first metallocene compound and the second metallocene compound is 40:60 to 45:55: 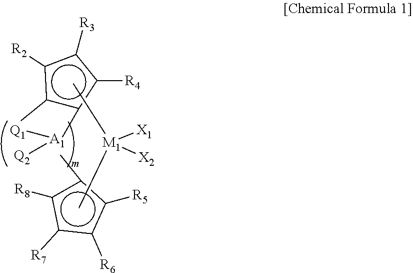
in Chemical Formula 1,
any one or more of R₁ to R₈ are —(CH₂)ₙ—OR, wherein R is C₁₋₆ linear or branched alkyl, and n is an integer of 2 to 6;
the rest of R₁ to R₈ are the same as or different from each other, and are each independently a functional group selected from the group consisting of hydrogen, halogen, C₁₋₂₀ alkyl, C₂₋₂₀ alkenyl, C₆₋₂₀ aryl, C₇₋₄₀ alkylaryl, and C₇₋₄₀ arylalkyl; or two or more of the substituents that are adjacent to each other are connected with each other to form a C₆₋₂₀ aliphatic or aromatic ring substituted or unsubstituted with a C₁₋₁₀ hydrocarbyl group;
Q₁ and Q₂ are the same as or different from each other, and are each independently hydrogen, halogen, C₁₋₂₀ alkyl, C₂₋₂₀ alkenyl, C₂₋₂₀ alkoxyalkyl, C₆₋₂₀ aryl, C₇₋₄₀ alkylaryl, or C₇₋₄₀ arylalkyl;
A₁ is carbon, silicon, or germanium;
M₁ is a Group 4 transition metal;
X₁ and X₂ are the same as or different from each other, and are each independently halogen, C₁₋₂₀ alkyl, C₂₋₂₀ alkenyl, C₆₋₂₀ aryl, nitro group, amido group, C₁₋₂₀ alkylsilyl, C₁₋₂₀ alkoxy, or a C₁₋₂₀ sulfonate group; and
m is an integer of 0 or 1, 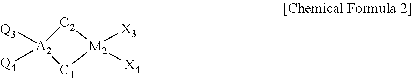
in Chemical Formula 2,
Q₃ and Q₄ are the same as or different from each other, and are each independently hydrogen, halogen, C₁₋₂₀ alkyl, C₂₋₂₀ alkenyl, C₂₋₂₀ alkoxyalkyl, C₆₋₂₀ aryl, C₇₋₄₀ alkylaryl, or C₇₋₄₀ arylalkyl;
A₂ is carbon, silicon, or germanium;
M₂ is a Group 4 transition metal;
X₃ and X₄ are the same as or different from each other, and are each independently halogen, C₁₋₂₀ alkyl, C₂₋₂₀ alkenyl, C₆₋₂₀ aryl, a nitro group, an amido group, C₁₋₂₀ alkylsilyl, C₁₋₂₀ alkoxy, or a C₁₋₂₀ sulfonate group; and
any one of C₁ and C₂ is represented by the following Chemical Formula 3a or 3b, and the other is represented by the following Chemical Formula 3c, 3d, or 3e; 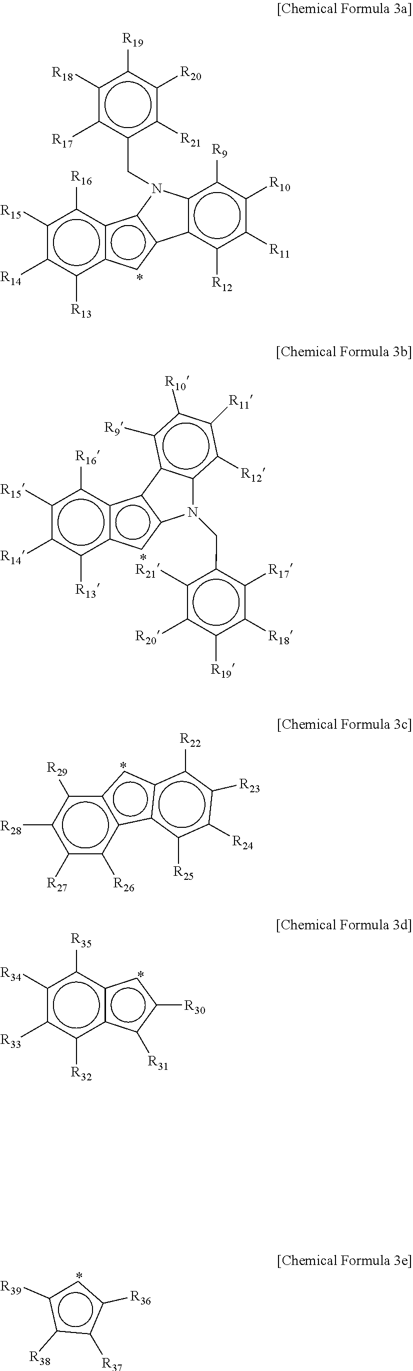
in Chemical Formulae 3a, 3b, 3c, 3d and 3e, R₉ to R₂₁ and R_{17′} to R_{21′} are the same as or different from each other, and are each independently hydrogen, halogen, C₁₋₂₀ alkyl, C₁₋₂₀ haloalkyl, C₂₋₂₀ alkenyl, C₁₋₂₀ alkylsilyl, C₁₋₂₀ silylalkyl, C₁₋₂₀ alkoxysilyl, C₁₋₂₀ alkoxy, C₆₋₂₀ aryl, C₇₋₄₀ alkylaryl, or C₇₋₄₀ arylalkyl, provided that one or more of R₁₇ to R₂₁ or one or more of R_{17′} to R_{21′} are C₁₋₂₀ haloalkyl;
R₂₂ to R₃₉ are the same as or different from each other, and are each independently hydrogen, halogen, C₁₋₂₀ alkyl, C₁₋₂₀ haloalkyl, C₂₋₂₀ alkenyl, C₁₋₂₀ alkylsilyl, C₁₋₂₀ silylalkyl, C₁₋₂₀ alkoxysilyl, C₁₋₂₀ alkoxy, C₆₋₂₀ aryl, C₇₋₄₀ alkylaryl, or C₇₋₄₀ arylalkyl, or two or more of R₂₂ to R₃₉ that are adjacent to each other are connected with each other to form a C₆₋₂₀ aliphatic or aromatic ring substituted or unsubstituted with a C₁₋₁₀ hydrocarbyl group; and
* represents a site of binding to A₂ and M₂.

9. The process for preparing the polyethylene according to claim 8, wherein the first metallocene compound is represented by any one of the following Chemical Formulae 1-1 to 1-4: 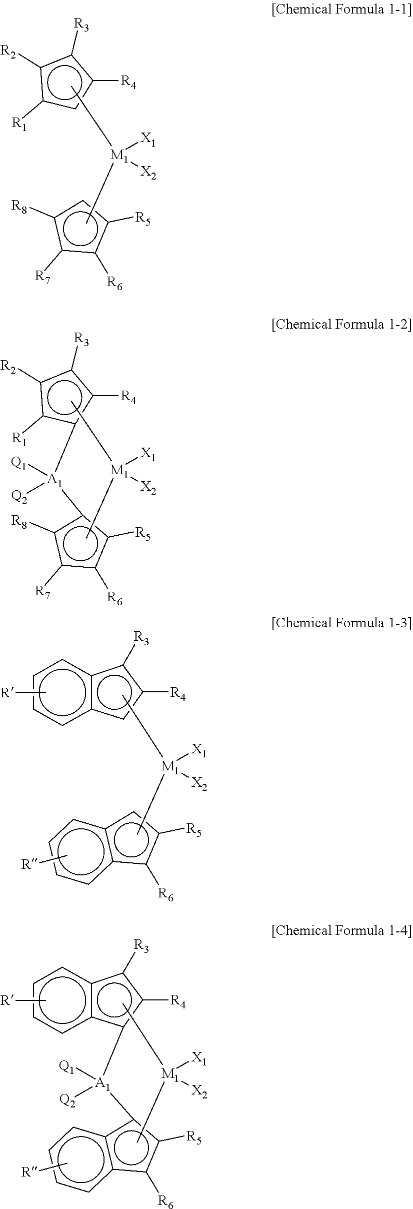
in Chemical Formulae 1-1 to 1-4,
Q₁, Q₂, A₁, M₁, X₁, X₂, and R₁ to R₈ are the same as defined in claim 8, and
R′ and R″ are the same as or different from each other, and are each independently a C₁₋₁₀ hydrocarbyl group.

10. The process for preparing the polyethylene according to claim 8, wherein R₃ and R₆ are each C₁₋₆ alkyl, or C₂₋₆ alkyl substituted with C₁₋₆ alkoxy.

11. The process for preparing the polyethylene according to claim 8, wherein the second metallocene compound is represented by the following Chemical Formula 2-1: 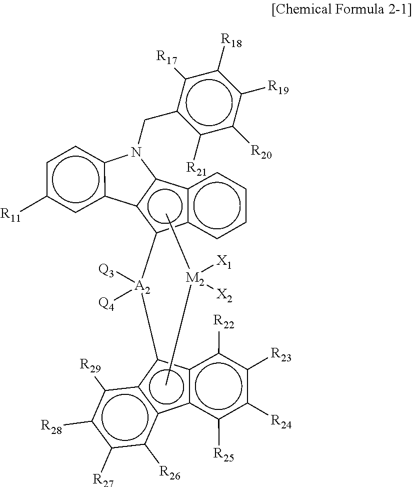
in Chemical Formula 2-1,
Q₃, Q₄, A₂, M₂, X₃, X₂₄, R₁₁, and R₁₇ to R₂₉ are the same as defined in claim 8.

12. The process for preparing the polyethylene according to claim 8, wherein R₁₇ to R₂₁ or R_{17′} to R_{21′} are each hydrogen, or C₁₋₆ haloalkyl, provided that any one or more of R₁₇ to R₂₁ or one or more of R_{17′} to R_{21′} are C₁₋₆ haloalkyl.

13. The process for preparing the polyethylene according to claim 8, wherein the step of polymerizing is performed by introducing a hydrogen gas in an amount of 100 ppm to 150 ppm, based on the content of ethylene.

14. A chlorinated polyethylene prepared by reacting the polyethylene according to claim 1 with chlorine.

15. The chlorinated polyethylene according to claim 14, wherein the chlorinated polyethylene has Mooney viscosity (MV) of 50 to 60, as measured under a condition of 121° C.; a hardness of 50 or less, as measured by Shore A in accordance with GB/T53; and a heat of fusion according to residual crystals (DSC 1st heating, 30° C. to 150° C. peak) of 1.5 J/g or less.
